(19) United States
(12) Patent Application Publication
(10) Pub. No.: US 2024/0155467 A1
(43) Pub. Date: May 9, 2024

(54) DELIVERY OF ON-DEMAND SIB USING SDT

(71) Applicant: Telefonaktiebolaget LM Ericsson (publ), Stockholm (SE)

(72) Inventors: Ritesh Shreevastav, Upplands Väsby (SE); Antonino Orsino, Kirkkonummi (FI); Jens Bergqvist, Linköping (SE); Henrik Enbuske, Stockholm (SE)

(21) Appl. No.: 18/280,536

(22) PCT Filed: Mar. 10, 2022
(86) PCT No.: PCT/IB2022/052178

§ 371 Date: Sep. 6, 2023

Related U.S. Application Data
(60) Provisional application No. 63/159,173, filed on Mar. 10, 2021.

(51) Int. Cl. H04W 48/12

(52) U.S. Cl. CPC H04W 48/12

(57) ABSTRACT

Systems and methods are disclosed related to on-demand system information using Small Data Transmission (SDT) procedures. In one embodiment, a method performed by a wireless communication device comprises, while in inactive state, transmitting a message to a network node, wherein the message comprises an identity (ID) of the wireless communication device and information that indicates one or more System Information Blocks (SIBs) and/or one or more position SIBs (posSIBs) being requested by the wireless communication device. Corresponding embodiments of a wireless communication device are also disclosed. Embodiments of a network node and a method of operation thereof are also disclosed.

### RELATED APPLICATIONS

This application claims the benefit of provisional patent application Ser. No. 63/159,173, filed Mar. 10, 2021, the disclosure of which is hereby incorporated herein by reference in its entirety.

### TECHNICAL FIELD

The present disclosure related to on-demand system information in a cellular communications system.

### BACKGROUND

Small data solutions have previously been introduced in Long Term Evolution (LTE) with the focus on Machine Type Communication (MTC). For example, Release 15 Early Data Transmission (EDT) and Release 16 Preconfigured Uplink Resources (PUR) have been standardized for LTE for MTC (LTE-M) and Narrowband Internet of Things (NB-IoT). Unlike these features, the Release 17 Small Data Transmission (SDT) for New Radio (NR) is not directly targeting MTC use cases, and the Work Item Description (WID) includes smartphone background traffic as the justification.

The Work Item (WI) objectives outline two main objectives: Random Access Channel (RACH)-based schemes and pre-configured Physical Uplink Shared Channel (PUSCH) resources. Comparing to LTE-M and NB-IoT, the 4-step RACH-based scheme is similar to Release 15 User Plane Early Data Transmission (UP-EDT), and pre-configured PUSCH resources is similar to Release 16 User Plane Preconfigured Uplink Resources (UP-PUR). Further, the Release 17 Small Data is only concerning data transmission in INACTIVE state and hence Control Plane (CP) optimizations of EDT and PUR are so far not relevant. 2-step RACH has not been specified for LTE, and hence there is no LTE counterpart for 2-step RACH-based SDT.

The 4-step RA type has been used in Fourth Generation (4G) LTE and is also the baseline for Fifth Generation (5G) NR. The principle of this procedure in NR is shown in FIG. 1. The steps of the 4-step RACH procedure are as follows.

Step 1—Preamble transmission: The User Equipment (UE) randomly selects a RA preamble (PREAMBLE_INDEX) corresponding to a selected Synchronization Signal (SS)/Physical Broadcast Channel (PBCH) block and transmits the preamble on the Physical Random Access Channel (PRACH) occasion mapped to the selected SS/PBCH block. When the next generation Node B (gNB) detects the preamble, it estimates the Timing Advance (TA) the UE should use in order to obtain uplink (UL) synchronization at the gNB.

Step 2—RA response (RAR): The gNB sends a RA response (RAR) including the TA, the Temporary Cell Radio Network Temporary Identifier (TC-RNTI) (temporary identifier) to be used by the UE, a Random Access Preamble identifier that matches the transmitted PREAMBLE_INDEX, and a grant for Msg3. The UE expects the RAR and, thus, monitors Physical Downlink Control Channel (PDCCH) addressed to Random Access Radio Network Temporary Identifier (RA-RNTI) to receive the RAR message from the gNB until the configured RAR window (ra-ResponseWindow) has expired or until the RAR has been successfully received.

From Third Generation Partnership Project (3GPP) Technical Specification (TS) 38.321: “The MAC entity may stop ra-ResponseWindow (and hence monitoring for Random Access Response(s)) after successful reception of a Random Access Response containing Random Access Preamble identifiers that matches the transmitted PREAMBLE_INDEX.”

Step 3—“Msg3” (UE ID or UE-specific C-RNTI): In Msg3, the UE transmits its identifier (UE ID, or more exactly the initial part of the 5G Temporary Mobile Subscriber Identity (5G-TMSI)) for initial access or, if it is already in RRC_CONNECTED or RRC_INACTIVE mode and needs to, e.g., re-synchronize, its UE-specific Radio Network Temporary Identifier (RNTI).

If the gNB cannot decode Msg3 at the granted UL resources, it may send a Downlink Control Information (DCI) addressed to TC-RNTI for retransmission of Msg3. Hybrid Automatic Repeat Request (HARQ) retransmission is requested until the UEs restart the random access procedure from step 1 after reaching the maximum number of HARQ retransmissions or until Msg3 can be successfully received by the gNB.

Step 4—“Msg4” (contention resolution): In Msg4, the gNB responds by acknowledging the UE ID or C-RNTI. The Msg4 gives contention resolution, i.e. only one UE ID or C-RNTI will be sent even if several UEs have used the same preamble (and the same grant for Msg3 transmission) simultaneously.

For Msg4 reception, the UE monitors TC-RNTI (if it transmitted its UE ID in Msg3) or C-RNTI (if it transmitted its C-RNTI in Msg3).

The 2-step RA type gives much shorter latency than the ordinary 4-step RA. In the 2-step RA, the preamble and a message corresponding to Msg3 (msgA PUSCH) in the 4-step RA can, depending on configuration, be transmitted in two subsequent slots. The msgA PUSCH is sent on a resource dedicated to the specific preamble. This means that both the preamble and the Msg3 face contention but contention resolution in this case means that either both preamble and Msg 3 are sent without collision or both collide. The 2-step RA procedure is depicted in FIG. 2.

Upon successful reception of msgA, the gNB responds with a msgB. The msgB may be either a “successRAR”, “fallbackRAR”, or “Back off”. The content of msgB has been agreed as seen below. It is noted in particular that fallbackRAR provides a grant for a Msg3 PUSCH that identifies resources in which the UE should transmit the PUSCH, as well as other information.

Note: The notations “msgA” and “MsgA” are used interchangeably herein to denote message A. Similarly, the notations “msgB” and “MsgB” are used interchangeably herein to denote message B.

The possibility to replace the 4-step message exchange by a 2-step message exchange would lead to reduced RA latency. On the other hand, the 2-step RA will consume more resources since it uses contention-based transmission of the data. This means that the resources that are configured for the data transmission may often be unused. Another difference is that 2-step RA operates without a timing advance (TA) since there is no feedback from gNB on how to adjust the uplink synchronization before the data payload is transmitted in MsgA PUSCH.

If both the 4-step and 2-step RA are configured in a cell on shared PRACH resources (and for the UE), the UE will choose its preamble from one specific set if it wants to do a 4-step RA, and from another set if it wants to do a 2-step RA. Hence, a preamble partition is done to distinguish between 4-step and 2-step RA when shared PRACH resources are used. Alternatively, the PRACH configurations are different for the 2-step and 4-step RA procedure, in which case it can be deduced from where the preamble transmission is done if the UE is doing a 2-step or 4-step procedure.

In the 3GPP Release 16 2-step RA type procedure, UEs are informed of the potential time-frequency resources where they may transmit MsgA PRACH and MsgA PUSCH via higher layer signaling from the network. PRACH is transmitted in periodically recurring RACH occasions (‘ROs’), while PUSCH is transmitted in periodically recurring PUSCH occasions (‘POs’). PUSCH occasions are described in MsgA PUSCH configurations provided by higher layer signaling. Each MsgA PUSCH configuration defines a starting time of the PUSCH occasions which is measured from the start of a corresponding RACH occasion. Multiple PUSCH occasions may be multiplexed in time and frequency in a MsgA PUSCH configuration, where POs in an Orthogonal Frequency Division Multiplexing (OFDM) symbol occupy a given number of Physical Resource Blocks (PRBs) and are adjacent in frequency, and where POs occupy ‘L’ contiguous OFDM symbols. POs multiplexed in time in a MsgA PUSCH configuration may be separated by a configured gap that is ‘G’ symbols long. The start of the first occupied OFDM symbol in a PUSCH slot is indicated via a start and length indicator value (‘SLIV’). The MsgA PUSCH configuration may comprise multiple contiguous PUSCH slots, each slot containing the same number of POs. The start of the first PRB relative to the first PRB in a bandwidth part (BWP) is also given by the MsgA PUSCH configuration. Moreover, the modulation and coding scheme (MCS) for MsgA PUSCH is also given by the MsgA PUSCH configuration.

Each PRACH preamble maps to a PUSCH occasion and a Demodulation Reference Signal (DMRS) port and/or a DMRS port-scrambling sequence combination according to a procedure given in 3GPP TS 38.213. This mapping allows a gNB to uniquely determine the location of the associated PUSCH in time and frequency as well as the DMRS port and/or scrambling from the preamble selected by the UE.

In regard to SDT procedures, NR supports RRC_INACTIVE state, and UEs with infrequent (periodic and/or aperiodic) data transmission (interchangeably referred to herein as small data transmission, or SDT) are generally maintained by the network not in RRC_IDLE but in the RRC_INACTIVE state. Until Release 16, the RRC_INACTIVE state does not support data transmission. Hence, the UE has to resume the connection (i.e., move to RRC_CONNECTED state) for any downlink (DL) data reception and any UL data transmission. Connection setup and subsequently release to RRC_INACTIVE state happens for each data transmission. This results in unnecessary power consumption and signaling overhead. For this reason, support for UE transmission in RRC_INACTIVE state using the random access procedure is introduced in Release 17. SDT is a procedure to transmit UL data from a UE in RRC_INACTIVE state. SDT is performed with either random access or configured grant (CG). The case in which the UE transmits UL data with random access can use both 4-step RA type and 2-step RA type (see description above). If the UE uses 4-step RA type for a SDT procedure, then the UE transmits the UL data in the Msg3. If the UE uses 2-step RA type for a SDT procedure, then the UE transmits UL data in the MsgA.

Two types of Configured Grant (CG) UL transmission schemes have been supported in NR since Release 15, referred as CG Type1 and CG Type2 in the standard. The major difference between these two types of CG transmission is that, for CG Type1, an uplink grant is provided by Radio Resource Control (RRC) configuration and activated automatically, while, in the case of CG Type2, the uplink grant is provided and activated via L1 signaling, i.e., by an UL DCI with Cyclic Redundancy Check (CRC) scrambled by Configured Scheduling Radio Network Temporary Identifier (CS-RNTI). In both cases, the spatial relation used for PUSCH transmission with Configured Grant is indicated by the uplink grant, either provided by the RRC configuration or by an UL DCI.

The CG periodicity is RRC configured, and this is specified in the ConfiguredGrantConfig Information Element (IE). Different periodicity values are supported in NR depending on the subcarrier spacing.

For use in SDT, the gNB may configure the UE with CG Type1 and may also configure Reference Signal Received Power (RSRP) threshold(s) for selection of an UL carrier. The configuration is given in the RRCRelease message sent to the UE while in connected state (to move the UE into Inactive state), or alternatively in another dedicated RRC message, for example while the UE is in RRC_CONNECTED. Alternatively, the configuration is given in RRCRelease message after a SDT procedure where the UE has started the procedure in RRC_INACTIVE and where the UE stays in RRC_INACTIVE after procedure completion. The use of Configured Grant type of resource requires the UE to remain in a synchronous state in that the time alignment is maintained. Should the UE be out of time alignment, a RA type of procedure can be initiated instead (above)

In regard to NR positioning, since Release 15 and the introduction in NR, the LTE Positioning Protocol (LPP) protocol, which is a point-to-point communication protocol between a Location Management Function (LMF) and a target device, has been agreed to be reused for UE positioning in both NR and LTE (3GPP TS 37.355).

At the core network, a new logical node called the LMF is the main server responsible for computing the UE position, based on the NR, Evolved Universal Terrestrial Radio Access (E-UTRA), or both Radio Access Technologies (RATs) specific positioning methods. NR Positioning Protocol A (NRPPA) is the communication protocol between a Next Generation Radio Access Network (NG-RAN) and the LMF.

The NR Positioning architecture is defined as illustrated in FIG. 3 (see also 3GPP TS 38.305)

New and enhanced positioning methods have been defined in NR (see TS 38.305) such as:
NR E-CID;
Multi-Round Trip Time (RTT) Positioning;
Downlink Angle-of-Departure (DL-AoD);
Downlink Time Difference of Arrival (DL-TDOA);
Uplink Time Difference of Arrival (UL-TDOA);
Uplink Angle of Arrival (UL-AoA), including the Azimuth of Arrival (A-AoA) and the Zenith of Arrival (Z-AoA).

Recent enhancements in Global Navigation Satellite System (GNSS) technology include Real Time Kinematic (RTK) GNSS, which is a differential GNSS positioning technology which enables positioning accuracy improvement from meter level to decimeter or even centimeter level in the right conditions in real-time by exploiting the carrier phase of the GNSS signal rather than only the code phase. Support for RTK GNSS in NR networks should therefore be provided and are under standardization in the Release 16 work item. Several positioning System Information Blocks (posSIBs) have been defined in LTE and NR for delivering RTK Assistance data. Further, there has been agreement to deliver Assistance data for Observed Time Difference of Arrival (OTDOA) and Sensor (barometric pressure sensor) for broadcast.

Below is the list of some of the posSIBs from 3GPP TS 37.355 v 16.3.0

### Start Excerpt from 3GPP TS 37.355 v16.3.0

Mapping of posSibType to Assistance Data Element
The supported posSibType's are specified in Table 7.2-1. The GNSS Common and Generic Assistance Data IEs are defined in clause 6.5.2.2. The OTDOA Assistance Data IEs are defined in clause 7.4.2.

TABLE 7.2-1
Mapping of posSibType to assistanceDataElement

| | posSibType [12] | assistanceDataElement |
|---|---|---|
| GNSS Common Assistance Data | posSibType1-1 | GNSS-ReferenceTime |
| (clause 6.5.2.2) | posSibType1-2 | GNSS-ReferenceLocation |
| | posSibType1-3 | GNSS-IonosphericModel |
| | posSibType1-4 | GNSS-EarthOrientationParameters |
| | posSibType1-5 | GNSS-RTK-ReferenceStationInfo |
| | posSibType1-6 | GNSS-RTK-CommonObservationInfo |
| | posSibType1-7 | GNSS-RTK-AuxiliaryStationData |
| GNSS Generic Assistance Data | posSibType2-1 | GNSS-TimeModelList |
| (clause 6.5.2.2) | posSibType2-2 | GNSS-DifferentialCorrections |
| | posSibType2-3 | GNSS-NavigationModel |
| | posSibType2-4 | GNSS-RealTimeIntegrity |
| | posSibType2-5 | GNSS-DataBitAssistance |
| | posSibType2-6 | GNSS-AcquisitionAssistance |
| | posSibType2-7 | GNSS-Almanac |
| | posSibType2-8 | GNSS-UTC-Model |
| | posSibType2-9 | GNSS-AuxiliaryInformation |
| | posSibType2-10 | BDS-DifferentialCorrections |
| | posSibType2-11 | BDS-GridModelParameter |
| | posSibType2-12 | GNSS-RTK-Observations |
| | posSibType2-13 | GLO-RTK-BiasInformation |
| | posSibType2-14 | GNSS-RTK-MAC-CorrectionDifferences |
| | posSibType2-15 | GNSS-RTK-Residuals |
| | posSibType2-16 | GNSS-RTK-FKP-Gradients |
| | posSibType2-17 | GNSS-SSR-OrbitCorrections |
| | posSibType2-18 | GNSS-SSR-ClockCorrections |
| | posSibType2-19 | GNSS-SSR-CodeBias |
| OTDOA Assistance Data (clause 7.4.2) | posSibType3-1 | OTDOA-UE-Assisted |

### End Excerpt from 3GPP TS 37.355 v16.3.0

On-demand System information request is a feature in NR that allows the network to only broadcast some of the system information messages when there is a UE that needs to acquire it. The UE requests such System Information messages using either msg1 or msg3 based procedures. The procedure allows a UE to request the needed information on-demand, and it allows the network to minimize the overhead in constantly broadcasting information that no UE is currently acquiring.

Further, in Release 16, System Information messages can be requested by UE and provided by the network also in dedicated state using the RRC Connection Reconfiguration message.

For the RRC on-demand system information (SI) framework, the parameter si-BroadcastStatus is used to indicate if an SI message is currently being broadcasted or not. This parameter is defined as:
si-BroadcastStatus ENUMERATED {broadcasting, notBroadcasting}

From the UE perspective, independent of whether an SI message is indicated as broadcasting or notBroadcasting, the UE obtains the SI scheduling information for the SI message from SIB1. If the SI message is indicated as broadcasting, the UE can then directly acquire the SI message based on the SI scheduling information. However, if the SI message is indicated as notBroadcasting, the UE first needs to perform the on-demand SI request procedure to the base station in order to initiate the transmission of the SI message (according to the SI scheduling information).

Currently, the on-demand broadcast is based upon the following msg1 and msg3 solutions:
Broadcast (Msg1 option):
   Msg1 SI Request RACH procedure (PRACH, “RAR”)
   Broadcast SI message (for some time)
Broadcast (Msg3 option):
   Msg3 SI Request RACH procedure (PRACH, RAR, RRCSystemInfoRequest, “Msg4”)
   Broadcast SI message (for some time)

Further in 3GPP Release 16, the UE can request on-demand SIB (including positioning SIBs) using a dedicated procedure as described in the following excerpt from 3GPP TS 38.331 v 16.3.0.

### Start Excerpt from 3GPP TS 38.331 v16.3.0

DedicatedSIBRequest
   The DedicatedSIBRequest message is used to request SIB(s) required by the UE in RRC_CONNECTED as specified in clause 5.2.2.3.5.
   Signalling radio bearer: SRB1

### RLC-SAP: AM

Logical channel: DCCH

### Direction: UE to Network

DedicatedSIBRequest message

-- ASN1START
-- TAG-DEDICATEDSIBREQUEST-START

| | |
|---|---|
| DedicatedSIBRequest-r16 ::= | SEQUENCE { |
| criticalExtensions | CHOICE { |
| dedicatedSIBRequest-r16 | DedicatedSIBRequest-r16-IEs, |
| criticalExtensionsFuture | SEQUENCE { } |

}
}

| | |
|---|---|
| DedicatedSIBRequest-r16-IEs ::= | SEQUENCE { |
| onDemandSIB-RequestList-r16 | SEQUENCE { |
| requestedSIB-List-r16 | SEQUENCE (SIZE (1..maxOnDemandSIB-r16)) OF SIB-ReqInfo- |
| r16 | OPTIONAL, |
| requestedPosSIB-List-r16 | SEQUENCE (SIZE (1..maxOnDemandPosSIB-r16)) OF PosSIB- |
| ReqInfo-r16 | OPTIONAL |

} OPTIONAL,

| | | |
|---|---|---|
| lateNonCriticalExtension | OCTET STRING | OPTIONAL, |
| nonCriticalExtension | SEQUENCE { } | OPTIONAL |

}

| | |
|---|---|
| SIB-ReqInfo-r16 ::= | ENUMERATED { sib12, sib13, sib14, spare5, spare4, spare3, |

spare2, spare1 }

| PosSIB-ReqInfo-r16 ::= | SEQUENCE { | |
|---|---|---|
| gnss-id-r16 | GNSS-ID-r16 | OPTIONAL, |
| sbas-id-r16 | SBAS-ID-r16 | OPTIONAL, |

| | |
|---|---|
| posSibType-r16 | ENUMERATED { posSibType1-1, posSibType1-2, posSibType1-3, |

```
posSibType1-4, posSibType1-5, posSibType1-6,
      posSibType1-7, posSibType1-8, posSibType2-1,
posSibType2-2, posSibType2-3, posSibType2-4,
      posSibType2-5, posSibType2-6, posSibType2-7,
posSibType2-8, posSibType2-9, posSibType2-10,
      posSibType2-11, posSibType2-12, posSibType2-13,
posSibType2-14, posSibType2-15,
      posSibType2-16, posSibType2-17, posSibType2-18,
posSibType2-19, posSibType2-20,
      posSibType2-21, posSibType2-22, posSibType2-23,
posSibType3-1, posSibType4-1,
      posSibType5-1, posSibType6-1, posSibType6-2,
posSibType6-3,... }
}
-- TAG-DEDICATEDSIBREQUEST-STOP
-- ASN1STOP
```

### End Excerpt from 3GPP TS 38.331 v16.3.0

### Summary

Systems and methods are disclosed related to on-demand system information using Small Data Transmission (SDT) procedures. In one embodiment, a method performed by a wireless communication device comprises, while in inactive state, transmitting a message to a network node, wherein the message comprises an identity (ID) of the wireless communication device and information that indicates one or more System Information Blocks (SIBs) and/or one or more position SIBs (posSIBs) being requested by the wireless communication device. In this manner, the wireless communication device is enabled to request on-demand system information without transitioning to connected mode.

In one embodiment, the message comprises a Medium Access Control (MAC) Control Element (CE) that comprises the information that indicates the one or more SIBs and/or the one or more posSIBs being requested by the wireless communication device. In one embodiment, the MAC CE further comprises an indication that the wireless communication device supports SDT functionality for requesting the one or more SIBs and/or the one or more posSIBs. In another embodiment, the wireless communication device indicates, to the network node, that the wireless communication device supports SDT functionality for requesting the one or more SIBs and/or the one or more posSIBs via: capability information reported to the network node, use of a Logical Channel Identity (LCID) or enhanced Logical Channel Identity (eLCID) in the MAC CE, or use of a certain random access preamble resource group for transmission of an associated random access preamble.

In one embodiment, the MAC CE further comprises the identity of the wireless communication device. In one embodiment, the identity of the wireless communication device is either an Inactive mode Radio Network Temporary Identifier (I-RNTI) or Short I-RNTI of the wireless communication device. In one embodiment, the MAC CE further comprises an indicator that indicates whether the identity of the wireless communication device comprised in the MAC CE is an I-RNTI or a Short I-RNTI.

In one embodiment, the MAC CE further comprises information that indicates whether the one or more SIBs and/or the one or more posSIBs being requested by the wireless communication device are one or more SIBs or one or more posSIBs.

In one embodiment, the MAC CE comprises a subheader that comprises eLCID, wherein the eLCID comprises a plurality of bits that that indicate which of a plurality of SIBs and/or posSIBs are being requested by the wireless communication device. In one embodiment, the MAC CE comprises a flag in the subheader or in the eLCID that indicates whether the one or more SIBs and/or the one or more posSIBs being requested by the wireless communication device are one or more SIBs or one or more posSIBs. In one embodiment, the eLCID further comprises the identity of the wireless communication device. In one embodiment, the identity of the wireless communication device is either an I-RNTI or Short I-RNTI of the wireless communication device. In one embodiment, the eLCID further comprises an indicator that indicates whether the identity of the wireless communication device comprised in the eLCID is an I-RNTI or a Short I-RNTI.

In one embodiment, the message comprises a Radio Resource Control (RRC) message that comprises the information that indicates the one or more SIBs and/or the one or more posSIBs being requested by the wireless communication device. In one embodiment, the RRC message further comprises an indication that the wireless communication device supports a SDT functionality for requesting the one or more SIBs and/or the one or more posSIBs and/or an indication of a capability of the wireless communication device to obtain SIBs and/or posSIBs via downlink SDT transmission. In one embodiment, the information that indicates the one or more SIBs and/or the one or more posSIBs being requested by the wireless communication device comprises a bitmap or explicit indication that indicates one or more SIBs and/or one or more posSIBs being requested by the wireless communication device.

In one embodiment, transmitting the message comprises transmitting the RRC message to be used for communication of SDT framework instead of a legacy RRC message that is normally used when transitioning from an idle/inactive state or in a connected state. In one embodiment, transmitting the message comprises embedding the RRC message comprising information that indicates a capability of receiving SIBs and/or posSIBs using SDT framework within a legacy RRC message that is normally used when transitioning from an idle/inactive state or in a connected state. In one embodiment, transmitting the message comprises transmitting the RRC message in either a Msg3 of a 4-step random access for a SDT procedure or MsgA of a 2-step random access for a SDT procedure.

In one embodiment, the identity of the wireless communication device is not included in the RRC message, but is included in a MAC CE transmitted by the wireless communication device to the network node either before or after the RRC message.

In one embodiment, the method further comprises receiving at least one of the one or more SIBs and/or at least one of the one or more posSIBs as part of a Msg 4 of an associated random access or as part of an RRC Release message.

In one embodiment, the method further comprises receiving at least one of the one or more SIBs and/or at least one of the one or more posSIBs via broadcast. In one embodiment, receiving the at least one of the one or more SIBs and/or the at least one of the one or more posSIBs via broadcast comprises receiving a broadcast status flag(s) associated to the at least one of the one or more SIBs and/or the at least one of the one or more posSIBs where the broadcast status flag(s) is(are) changed to indicate that the at least one of the one or more SIBs and/or the at least one of the one or more posSIBs are broadcasted.

In one embodiment, the method further comprises receiving a message that disables the request for the one or more SIBs and/or the one or more posSIBs.

In one embodiment, transmitting the message comprises transmitting a MsgA in a 2-step random access, where the MsgA comprises a random access preamble, a RRC Resume Request, data, and the message.

In one embodiment, transmitting the message comprises transmitting (1002) a Msg3 in a 4-step random access, where the Msg3 comprises a RRC Resume Request, data, and the message.

Corresponding embodiments of a wireless communication device are also disclosed. In one embodiment, a wireless communication device is adapted to, while in inactive state, transmit a message to a network node, wherein the message comprise an ID of the wireless communication device and information that indicates one or more SIBs and/or one or more posSIBs being requested by the wireless communication device.

In another embodiment, a wireless communication device comprises one or more transmitters, one or more receivers, and processing circuitry associated with the one or more transmitters and the one or more receivers. The processing circuitry is configured to cause the wireless communication device to, while in inactive state, transmit a message to a network node, wherein the message comprise an ID of the wireless communication device and information that indicates one or more SIBs and/or one or more posSIBs being requested by the wireless communication device.

Embodiments of a method performed by a network node are also disclosed. In one embodiment, a method performed by a network node comprises, while a wireless communication device is in an inactive state, receiving a message from the wireless communication device, wherein the message comprises an ID of the wireless communication device and information that indicates one or SIBs and/or one or more posSIBs being requested by the wireless communication device.

Corresponding embodiments of a network node are also disclosed. In one embodiment, a network node is adapted to, while a wireless communication device is in an inactive state, receive a message from the wireless communication device, wherein the message comprises an ID of the wireless communication device and information that indicates one or SIBs and/or one or more posSIBs being requested by the wireless communication device.

In another embodiment, a network node comprises processing circuitry configured to cause the network node to, while a wireless communication device is in an inactive state, receive a message from the wireless communication device, wherein the message comprises an ID of the wireless communication device and information that indicates one or SIBs and/or one or more posSIBs being requested by the wireless communication device.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrate the 4-step Random Access (RA) procedure used in Third Generation Partnership Project (3GPP) Long Term Evolution (LTE) and New Radio (NR);

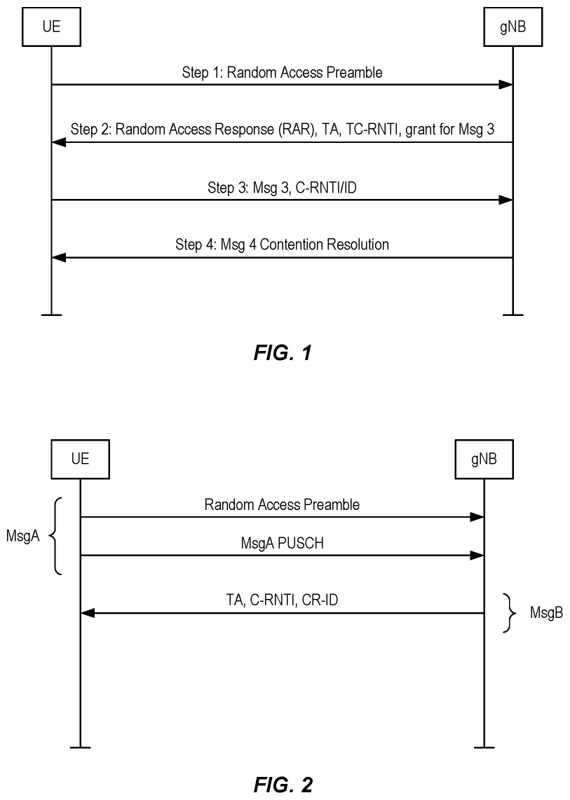

FIG. 2 illustrates the 2-step RA procedure defined in 3GPP;

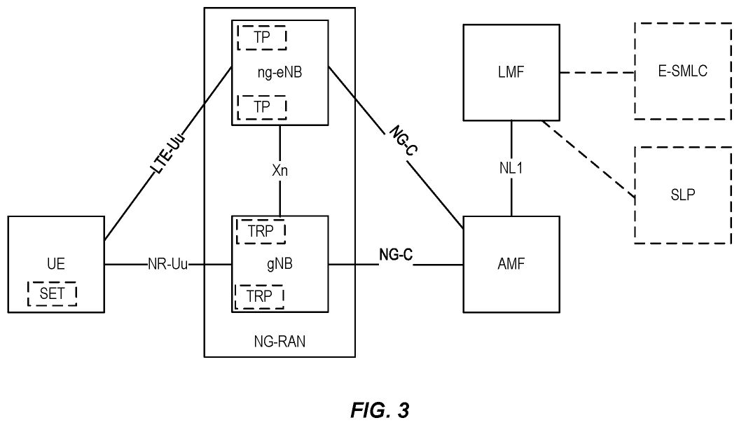

FIG. 3 illustrates the NR positioning architecture defined in 3GPP;

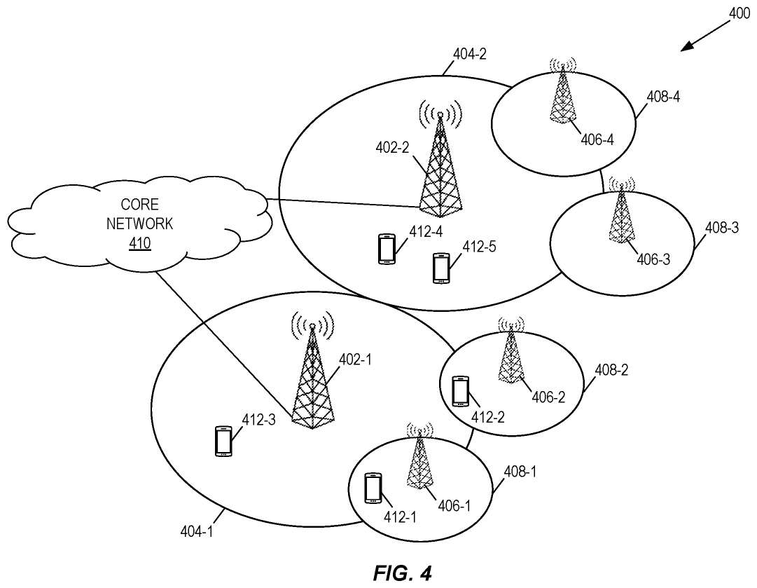

FIG. 4 illustrates one example of a cellular communications system in which embodiments of the present disclosure may be implemented;

FIG. 5 illustrates one example implementation of Medium Access Control (MAC) Control Element (CE) in accordance with an embodiment of the present disclosure;

FIG. 6 illustrates one example embodiment of the payload of the MAC CE of FIG. 5;

FIG. 7 illustrates the operation of a User Equipment (UE) and a network node in accordance with an embodiment of the present disclosure;

FIG. 8 illustrates the operation of a UE and a network node in accordance with another embodiment of the present disclosure;

FIG. 9 illustrates an example Small Data Transmission (SDT) procedure that uses a 4-step RA process to request and obtain on-demand system information in accordance with one embodiment of the present disclosure;

FIG. 10 illustrates an example SDT procedure that uses a 4-step RA process to request and obtain on-demand system information in accordance with another embodiment of the present disclosure;

FIGS. 11, 12, and 13 are schematic block diagrams of example embodiments of a network node in which aspects of embodiments of the present disclosure may be implemented;

FIGS. 14 and 15 are schematic block diagrams of example embodiments of a wireless communication device (specifically as UE) in which aspects of embodiments of the present disclosure may be implemented;

FIG. 16 illustrates an example embodiment of a communication system in which embodiments of the present disclosure may be implemented;

FIG. 17 illustrates example embodiments of the host computer, base station, and UE of FIG. 16;

FIGS. 18 through 21 are flow charts that illustrate example embodiments of methods implemented in a communication system such as that of FIG. 16;

FIG. 22 illustrates an example RRCSystemInfoRequest message in accordance with an embodiment of the present disclosure;

FIG. 23 illustrates an example in which the bitmap or explicit indication of requested System Information Blocks (SIBs) or positioning SIBs (posSIBs) is added in an RRCSystemInfoRequest message; and

FIG. 24 illustrates an RRCResumeRequest that may be used in an embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). With the current solution for on-demand system information, the network cannot deliver UEs System Information Block (SIB) requested via Inactive mode procedures. A UE may request on-demand system information using msg1 or msg3 (in the inactive state), but the network cannot deliver via point to point (unicast) message.

Further, the UE cannot transition to connected mode just for requesting SIBs that are currently not being broadcasted; i.e., the network cannot deliver requested on-demand system information via a connected mode procedure if the request was not made by a UE in connected mode. This is a constraint from the network perspective as it would consume large broadcast resources especially when the on-demand request originates from one UE (or very few) or even large number of UEs but in separate time occasions; in such case, the network cannot deliver point to point and is forced to deliver using broadcast.

Thus, there is a need for systems and methods in this direction for on-demand SIB delivery.

Certain aspects of the present disclosure and their embodiments may provide solutions to the aforementioned or other challenges. In the present disclosure, embodiments of a system and method for on-demand system information (SI) request and delivery using a Small Data Transmission (SDT) framework are provided.

In one embodiment, a Medium Access Control (MAC) based procedure for on-demand SI request and delivery using the SDT framework is provided. In one embodiment, the MAC based procedure includes one or more of the following:
An existing Logical Channel Identity (LCID)/enhanced LCID (eLCID) for SDT or a new LCID/eLCID is defined where the UE includes or uses this as part of MsgA/Msg3 Transmission.
The MAC CE including this LCID/eLCID has payloads with the SIBs request (e.g., Bit indicating which SIB is requested).
Upon receiving such a request, the network (e.g., a network node) provides downlink (DL) Data using SDT framework (e.g., as part of Msg4/RRCRelease) message or subsequent DL transmission in Inactive state.

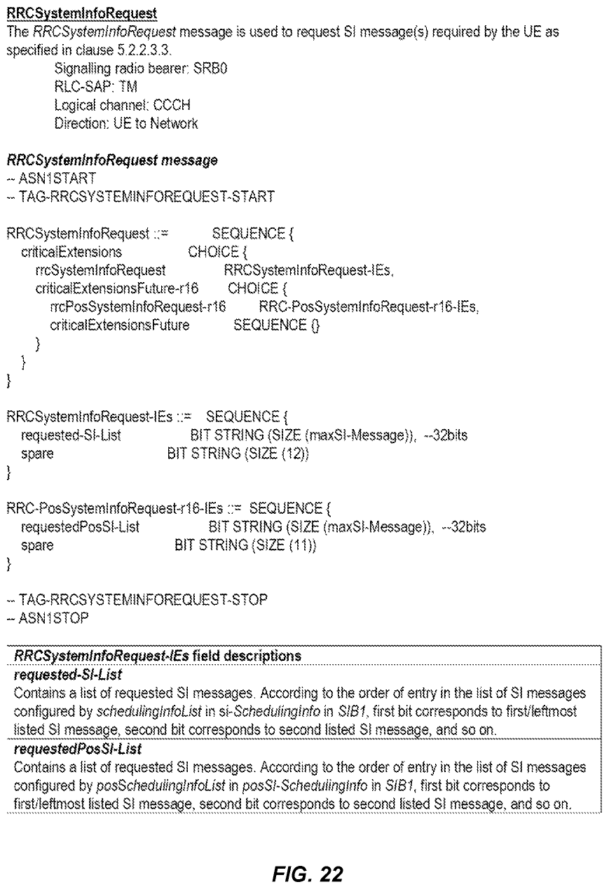

In another embodiment, a Radio Resource Control (RRC) based procedure for on-demand SI request and delivery using the SDT framework is provided. In one embodiment, the RRC based procedure includes one or more of the following:
The network provides information via SIB broadcast that SDT based delivery is supported or enabled/disabled. This can also be provided by dedicated signaling.
A spare bit from the RRCSystemInfoRequest-IEs of the RRCSystemInfoRequest illustrated in FIG. 22 is used to indicate that UE supports SDT, and the network may choose to deliver by means of point-to-point delivery.
Instead of the below RRCSystemInfoRequest message, it is possible that the UE sends a new RRC message for SDT request and includes the capability of obtaining SIBs (posSIBs) via DL SDT transmission with a flag bit.
Alternatively, the network may also determine that the UE is supporting SDT based upon the use of new LCID/eLCID in MAC CE.

Certain embodiments may provide one or more of the following technical advantage(s). Embodiments of present disclosure may provide one or more of the following advantages:
Power saving mechanisms are essential for RAN based procedures. According to embodiments described herein, the UE is able to transmit and receive data while keeping the RRC status to RRC_INACTIVE and thus avoiding transitioning to RRC_CONNECTED. This means that higher signaling overhead and power consumption to achieve the RRC transition is avoided.
Embodiments of the present disclosure may provide network resource savings as the network does not have to deliver the SIB using broadcast.
Embodiments of the present disclosure may be especially useful where the UE can use this mechanism to retrieve positioning SIBs (posSIBs) such as Global Navigation Satellite System (GNSS) Almanac or reference stations which are slow varying or static and can also be large data not suitable for broadcast.

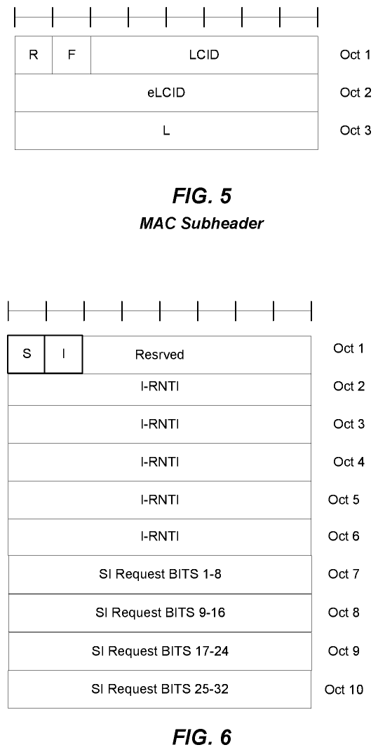

FIG. 4 illustrates one example of a cellular communications system 400 in which embodiments of the present disclosure may be implemented. In the embodiments described herein, the cellular communications system 400 is a 5G system (5GS) including a Next Generation RAN (NG-RAN) and a 5G Core (5GC); however, the present disclosure is not limited thereto. The embodiments described herein can be implemented in other types of cellular communications systems (e.g., an Evolved Packet System (EPS)) in which Small Data Transmission (SDTs) are desired. In this example, the RAN includes base stations 402-1 and 402-2, which in the NG-RAN include NR base stations (gNBs) and optionally next generation eNBs (ng-eNBs) (e.g., LTE RAN nodes connected to the 5GC), controlling corresponding (macro) cells 404-1 and 404-2. The base stations 402-1 and 402-2 are generally referred to herein collectively as base stations 402 and individually as base station 402. Likewise, the (macro) cells 404-1 and 404-2 are generally referred to herein collectively as (macro) cells 404 and individually as (macro) cell 404. The RAN may also include a number of low power nodes 406-1 through 406-4 controlling corresponding small cells 408-1 through 408-4. The low power nodes 406-1 through 406-4 can be small base stations (such as pico or femto base stations) or Remote Radio Heads (RRHs), or the like. Notably, while not illustrated, one or more of the small cells 408-1 through 408-4 may alternatively be provided by the base stations 402. The low power nodes 406-1 through 406-4 are generally referred to herein collectively as low power nodes 406 and individually as low power node 406. Likewise, the small cells 408-1 through 408-4 are generally referred to herein collectively as small cells 408 and individually as small cell 408. The cellular communications system 400 also includes a core network 410, which in the 5G System (5GS) is referred to as the 5GC. The base stations 402 (and optionally the low power nodes 406) are connected to the core network 410.

The base stations 402 and the low power nodes 406 provide service to wireless communication devices 412-1 through 412-5 in the corresponding cells 404 and 408. The wireless communication devices 412-1 through 412-5 are generally referred to herein collectively as wireless communication devices 412 and individually as wireless communication device 412. In the following description, the wireless communication devices 412 are oftentimes UEs and as such sometimes referred to as UEs 412, but the present disclosure is not limited thereto.

In the following, embodiments are described in the context of NR but can be applied without any loss of meaning also to LTE or any other Radio Access Technology (RAT). Further, the terms “posSIB”, “positioning SIB”, and “positioning information” refer to system information related to positioning that can be generally acquired by the UE via broadcast or via dedicated RRC signaling. Also, the terms “SIB” and “normal SIB” refer to the system information not related to position and that also can be acquired via broadcast or via dedicated RRC signaling.

In the following, the terms posSIB or SIB can be exchanged without loss of meaning since the same embodiments, methods, and solution can be applied to both posSIB or SIB.

As used herein, the term “Inactive mode Radio Network Temporary Identifier (I-RNTI) or “I-RNTI-Value” is used to identify the suspended UE context of a UE in RRC_INACTIVE. In one embodiment, the I-RNTI-Value is an information element defined as:

I-RNTI-Value information element

-- ASN1START
-- TAG-I-RNTI-VALUE-START
I-RNTI-Value ::= BIT STRING (SIZE(40))
-- TAG-I-RNTI-VALUE-STOP
-- ASN1STOP

As used herein, the term “ShortI-RNTI-Value” is used to identify the suspended UE context of a UE in RRC_INACTIVE using fewer bits compared to I-RNTI-Value. In one embodiment, the ShortI-RNTI-Value is an information element defines as:

ShortI-RNTI-Value information element

-- ASN1START
-- TAG-SHORTI-RNTI-VALUE-START
ShortI-RNTI-Value ::= BIT STRING (SIZE(24))
-- TAG-SHORTI-RNTI-VALUE-STOP
-- ASN1STOP

### MAC Based Solution

In one embodiment, if the UE 412 is in RRC_INACTIVE and has the need to (re)acquire a SIB(s) or posSIB(s), the UE 412 sends a new uplink MAC Control Element (CE) to the network (e.g., to a network node such as, e.g., the base station 402 or a network node that implements at least part of the functionality of the base station 402) in order to indicate which SIB(s) or posSIB(s) is needed (i.e., without transitioning completely to RRC_CONNECTED).

Also, the use case can be such that the UE 412 is in RRC_INACTIVE and has the need to (re)acquire a SIB or posSIB that is indicated by the network (e.g., by a network node) to only be provided by point-to-point delivery (i.e., without broadcast), and then the UE 412 sends this request through MAC CE. For example, via unicast tag.

The need to (re)acquire a SIB(s) or posSIB(s) may be due to the following reasons:
a request from an upper layer at the UE 412,
a stored SIB(s) or posSIB(s) at the UE 412 is outdated or not valid anymore, or
a particular SIB(s) or posSIB(s) is requested to be acquired to configure or perform a certain functionality (e.g., Sidelink or Non-private network).

Further, in another embodiment, when the sending the uplink MAC CE to the network (e.g., to the network node), the UE 412 may also indicate to the network (e.g., to the network node) (e.g., via the MAC CE) that this particular UE 412 supports the SDT functionality for requesting the SIB(s) or posSIB(s) and wants to use it. Alternatively, the network may understand whether a particular UE 412 support SDT functionality for requesting the SIB(s) or posSIB(s) via the UE capability or the use of LCID/eLCID in MAC CE or use of certain preamble resource group.

In one embodiment, upon receiving the request of the UE 412 via the uplink MAC CE that one (or more) SIBs or posSIBs are requested, the network node (e.g., the base station 402 such as, e.g., the gNB) may decide to perform the following actions:
1. the network node sends a new downlink MAC CE to the UE 412 to disable the SIB(s) or posSIB(s) request via the SDT framework, or
2. the network node sends the requested SIB(s) or posSIB(s) as part of Msg4 or RRCRelease according to the SDT framework, or
3. the network node broadcasts the requested SIB(s) or posSIB(s) (e.g., by changing the broadcasting status flag from notBroadcasting to broadcasting).

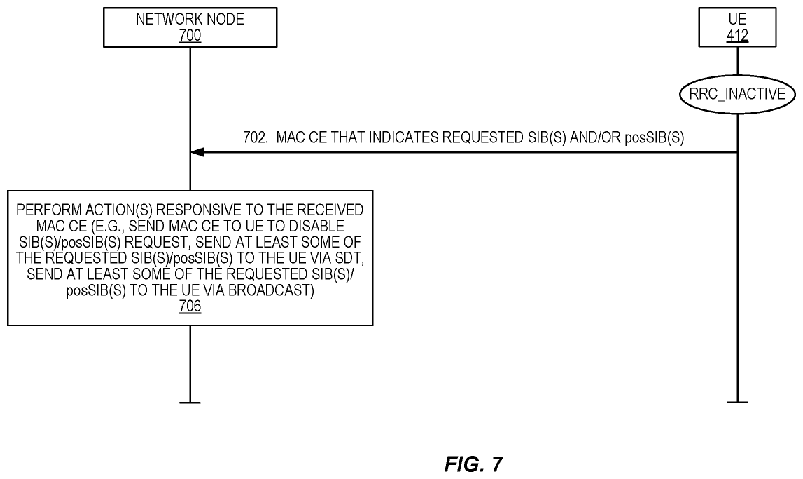

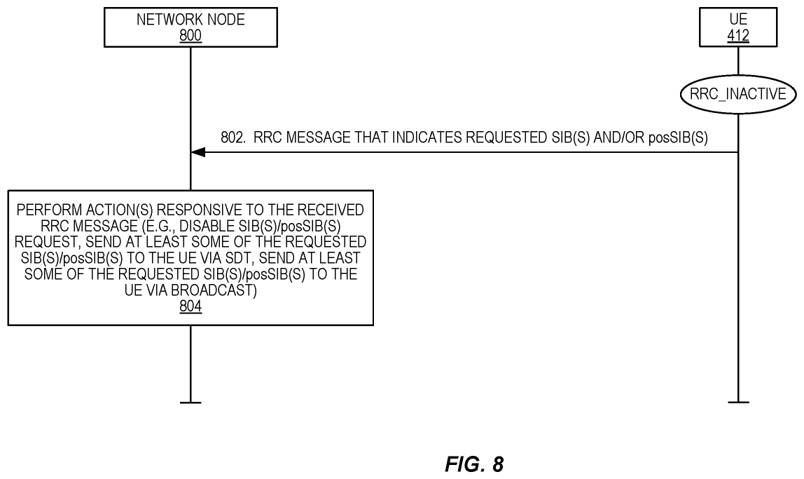

In another embodiment, a possible implementation of what is described above may include that a new eLCID is defined and the payload would contain 32 bits (maxSI message), as illustrated in FIG. 5. Further, in one embodiment, the payload is as shown in FIG. 6. The R-bit from FIG. 5 or new flag S shown in FIG. 6 can also be used to distinguish whether the request is for SIB or posSIB in the MAC payload. Further, the MAC payload may also contain the UE ID (e.g., I-RNTI) which may be, e.g., either 24 bits or 40 bits. In one embodiment, there can be a flag to distinguish also that (an example; I) as shown in FIG. 6; hence, the MAC CE payload can be, for example, 10 bytes or 8 bytes. The network (e.g., network node) may deduce the I-RNTI type (e.g., short or long) based upon the MAC payload size (e.g., difference of 2 bytes).

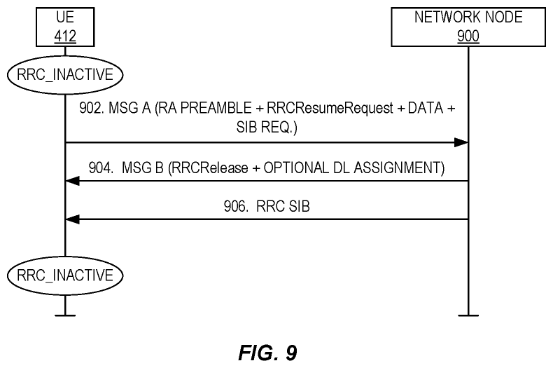

FIG. 7 illustrates the operation of a UE 412 and a network node 700 (e.g., a base station 402 or a network node that implements at least some of the functionality of a base station 402) in accordance with an embodiment of the MAC based solution described above. As illustrated, the UE 412, when in inactive state, sends a MAC CE to the network node 700, where the MAC CE indicates one or more SIBs and/or one or more posSIBs requested by the UE 412 (step 702). In addition, in one embodiment, the MAC CE further includes an indication that the UE 412 supports SDT functionality for requesting the SIB(s) and/or posSIB(s) and wants to use this functionality. In another embodiment, the network node 700 determines whether the UE 412 supports SDT functionality for requesting the SIB(s) and/or posSIB(s) via UE capabilities (e.g., UE capabilities previously reported by the UE 412), the use of a LCID or eLCID in the MAC CE that indicates that the UE 412 supports the SDT functionality, or the use of a certain RA preamble resource group by the UE 412 when transmitting an associated RA preamble. Responsive to receiving the MAC CE, the network node 700 performs one or more actions (step 704). The one or more actions performed by the network node 700 may include sending a new downlink MAC CE to the UE 412 to disable the SIB or posSIB request, sending at least one of the requested SIB(s) and/or pos(SIBs) to the UE 412 via SDT, e.g., as part of an associated Msg4 or RRCRelease, and/or broadcasting at least one of the requested SIB(s) and/or posSIB(s) (e.g., by changing the broadcasting status flag from notBroadcasting to broadcasting).

### RRC Based Solution

In one embodiment, if the UE 412 is in RRC_INACTIVE and has the need to (re)acquire a SIB(s) or posSIB(s), the UE 412 sends an uplink RRC message to the network in order to request the needed SIB(s) or posSIB(s) (i.e., without transitioning completely to RRC_CONNECTED). In one embodiment, the uplink RRC request is sent according to the following:
A bitmap or an explicit indication is added in an existing RRC message in order to indicate to the network which SIB(s) or posSIB(s) is(are) needed.
This new bitmap or explicit indication is conveyed to the network (e.g., to a network node) according to either of the following options:
1. A new or an existing RRC message is sent to the network in order to indicate to the network which SIB(s) or posSIB(s) is (are) needed, and this new RRC message will be used instead of one of the legacy RRC messages normally used when performing the transition from RRC_IDLE to RRC_CONNECTED (e.g., instead of the RRCResumeRequest).
2. A new or an existing RRC message is sent to the network embedded (i.e., in a container—OCTET STRING) in one of the legacy RRC messages normally used when performing the transition from RRC_IDLE to RRC_CONNECTED (e.g., instead of the RRCResumeRequest).

Further, if the UE 412 uses 4-step RA type for SDT procedure, then the UE 412 transmits the UL messages in the Msg3. If the UE 412 uses 2-step RA type for SDT procedure, then the UE 412 transmits UL messages in the MsgA.

In another embodiment, when sending the uplink RRC request to the network, the UE 412 may also indicate (e.g., in the RRC message) to the network that this particular UE 412 supports the SDT functionality for requesting the SIB(s) or posSIB(s) and wants to use it. Alternatively, the network may understand whether the particular UE 412 support SDT functionality for requesting the SIB(s) or posSIB(s) via the UE capability.

In one embodiment, the network (e.g., network node) may also enable/disable the SDT functionality for requesting the SIB(s) or posSIB(s) via adding an indication in SIB (if the network wants to disable this functionality to all UE under its coverage) or via adding an indication in a dedicated RRC message (if the network wants to disable this functionality to only a particular UE under its coverage).

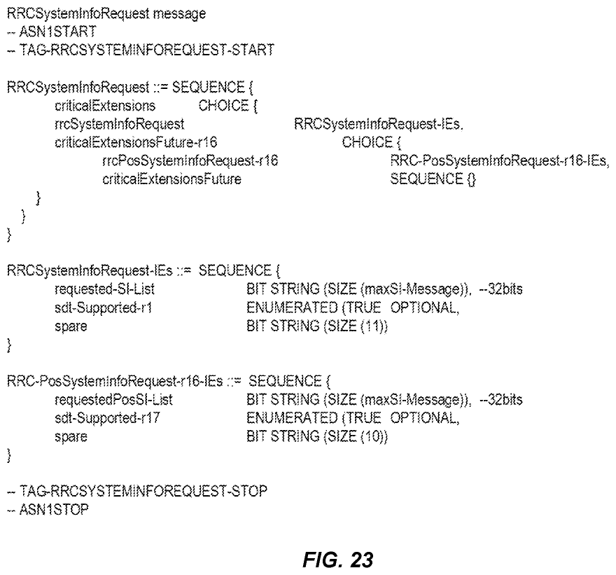

In another embodiment, a possible implementation of what is described above is as follows. A bitmap or an explicit indication is added in an existing RRC message or new RRC message in order to indicate to the network with SIB/posSIB are needed. FIG. 23 illustrates an example in which the bitmap or explicit indication is added in an RRCSystemInfoRequest message.

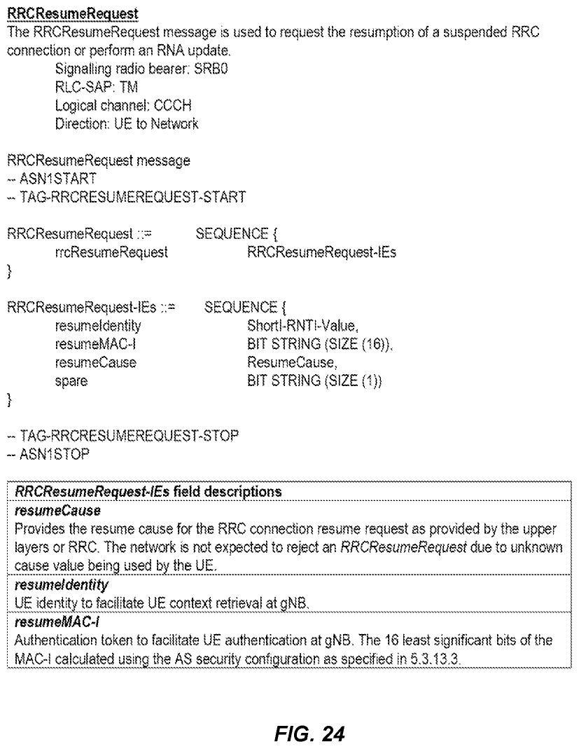

Further, as the above RRC message does not have UE ID, this RRCSystemInfo message is appended after a specific MAC CE as shown in FIG. 6 containing the UE ID (e.g., I-RNTI) or after the RRC Resume request message of FIG. 24. In such case, the MAC payload may not contain the SI request octets and would instead be provided via the RRC message.

In an embodiment, a separate Preamble group is reserved for transmitting SIB or PosSIB request for UEs supporting SDT functionality. Upon receiving such Preamble, the network would allocate an UL grant that would fit:
MAC CE+RRC Resume Request+RRC System Info Request Msg

It is also possible to create a new RRC Msg which includes the UE ID+BITMAP of requested SIBs or posSIBs or to append the required attributes (BITMAP of requested SIBs/posSIBs) in any SDT specific RRC message.

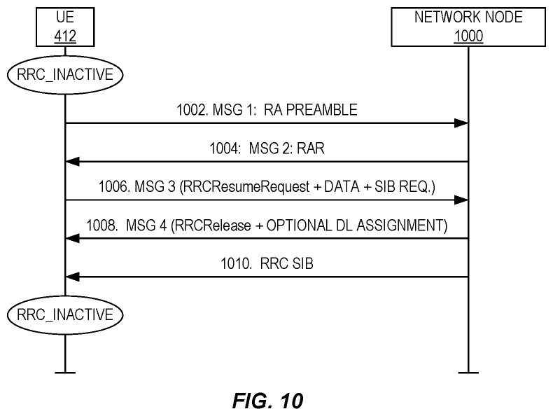

FIG. 8 illustrates the operation of a UE 412 and a network node 700 (e.g., a base station 402 or a network node that implements at least some of the functionality of a base station 402) in accordance with an embodiment of the RRC based solution described above. As illustrated, the UE 412, when in inactive state, sends a RRC message to the network node 700, where the RRC message indicates one or more SIBs and/or one or more posSIBs requested by the UE 412 (step 802). The RRC message may be in accordance with any of the embodiments described above. Thus, the details described above are equally applicable here. Note that, in one embodiment, the RRC message is a (new) RRC message for SDT request and includes an indication of the capability of the UE 412 to obtain SIBs and/or posSIBs via downlink SDT transmission (e.g., a flag bit that indicates the capability of the UE 412 to obtain SIBs and/or posSIBs via downlink SDT transmission).

Responsive to receiving the RRC message, the network node 700 performs one or more actions (step 804). The one or more actions performed by the network node 800 may include disable the SIB or posSIB request, sending at least one of the requested SIB(s) and/or pos(SIBs) to the UE 412 via SDT, e.g., as part of an associated Msg4 or RRCRelease, and/or broadcasting at least one of the requested SIB(s) and/or posSIB(s) (e.g., by changing the broadcasting status flag from notBroadcasting to broadcasting).

### SDT Procedure and Network Delivery of SIB Via SDT

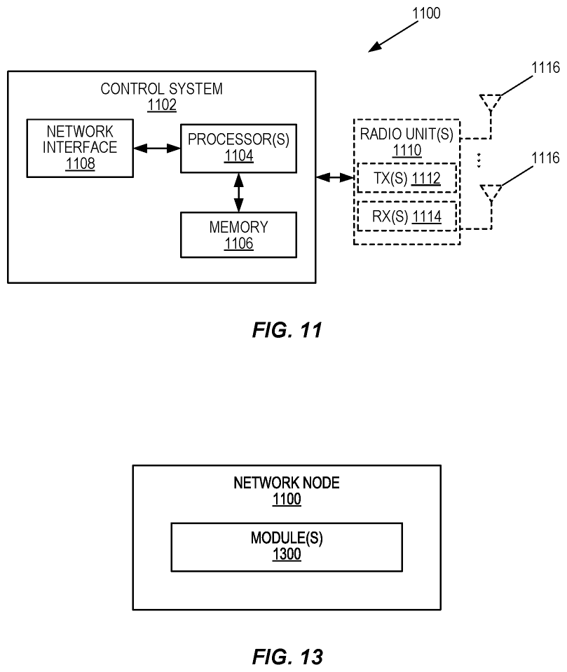

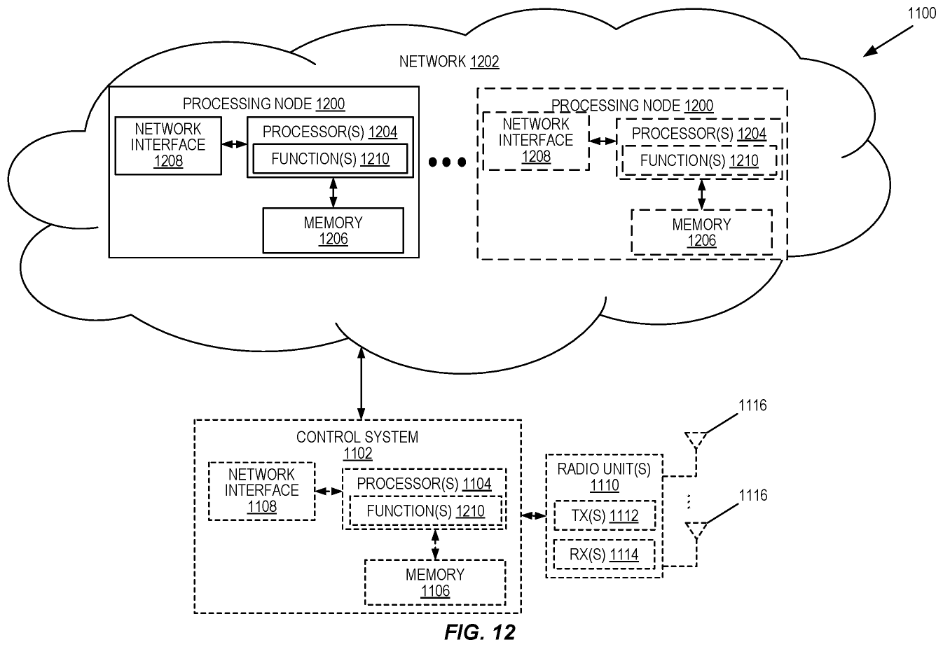

Example procedures are illustrated in FIGS. 9 and 10. The procedure of FIG. 9 is illustrated with respect to 2-step RA. The procedure of FIG. 10 is illustrated with respect to 4-step RA. As illustrated in FIG. 9, in MsgA, the UE 412 transmits, to a network node 900, a RRCResumeRequest+SmallData (possibly segmented)+SIB request indication (step 902). In MsgB, the network node 900 sends (step 904):
RRCrelease if no other data expected, no config update pursued, or
RRC connection request+possibly a dynamic grant to move UE to connected, or
RRCrelease+Downlink assignment+possibly a configured grant configuration/single UL configured grant.

As illustrated in FIG. 10, after the UE 412 transmits the RA preamble to a network node 1000 (step 1002) and receives a RAR from the network node 1000 (step 1004), in Msg3, the UE 412 transmits, to the network node 1000, a RRCResumeRequest+SmallData (possibly segmented)+SIB request indication (step 1006). In Msg4, the network node 1000 sends (step 1008):
RRCrelease if no other data expected, no config update pursued, or
RRC connection request+possibly a dynamic grant to move UE to connected, or
RRCrelease+Downlink assignment+possibly a configured grant configuration/single UL configured grant.

In one embodiment, the network node 900 or 1000 receives a first SDT message through MsgA or Msg3, or alternatively in a configured grant allocation. The network node 900 or 1000 detects that subsequent SDT transmissions are pending through either:
that the user data in the MAC Sub Protocol Data Unit (PDU) is a segmented Radio Link Control (RLC) payload,
or by an explicit indication, e.g. SIB request, or both in addition,
or alternatively by receiving the SIB RRC configuration request using a method as described in this document in previous sections

The network node 900 or 1000 then may provide a SIB RRC message to the UE 412 (step 906 or step 1010). The network node 900 or 1000 may provide the SIB RRC message to the UE 412 by the following means:
RRCRelease is accompanied with a subsequent downlink assignment for which the UE 412 stays in RRC INACTIVE until successfully decoded.
   The DL assignment (c.f. SPS, Semi Persistent Scheduling) contains the SIB RRC configuration
A DL assignment (grant) scheduled by the network node 900, for which after successful decoding follows with a RRC release message.

### RRC Procedure Description (Impacts on 3GPP TS 38.331 Chapter 5)

The below contains an example of 3GPP TS 38.331 procedural changes that implement at least some aspects of the embodiments described above. The example shows how existing procedure needs to be updated to accommodate SDT based procedure. Further, it is possible to have a separate on-demand SI procedure for SDT based Inactive mode mechanism.

### 5.2.2.3.3 Request for On-Demand System Information

The UE shall:
1> if SIB1 includes si-Schedulinglnfo containing si-RequestConfigSUL and criteria to select supplementary uplink as defined in TS 38.321[13], clause 5.1.1 is met:
   2> If SIB1 includes si-Schedulinalnfocontaininq sdtSupported, triqqcer the lower layer to initiate the Small Data Transmission procedure on supplementary uplink in accordance with TS MAC specification using the PRACH preamble(s) and PRACH resource(s) in si-RequestConfigSUL corresponding to the SI message(s) that the UE requires to operate within the cell, and for which si-BroadcastStatus is set to notBroadcastinc;
      3> retrieve/receive the requested SI message(s) via downlink small data transmission:
   2> else trigger the lower layer to initiate the Random Access procedure on supplementary uplink in accordance with [3] using the PRACH preamble(s) and PRACH resource(s) in si-RequestConfigSUL corresponding to the SI message(s) that the UE requires to operate within the cell, and for which si-BroadcastStatus is set to notBroadcasting;
      3> if acknowledgement for SI request is received from lower layers:
         4> acquire the requested SI message(s) as defined in sub-clause 5.2.2.3.2, immediately;

### Additional Aspects

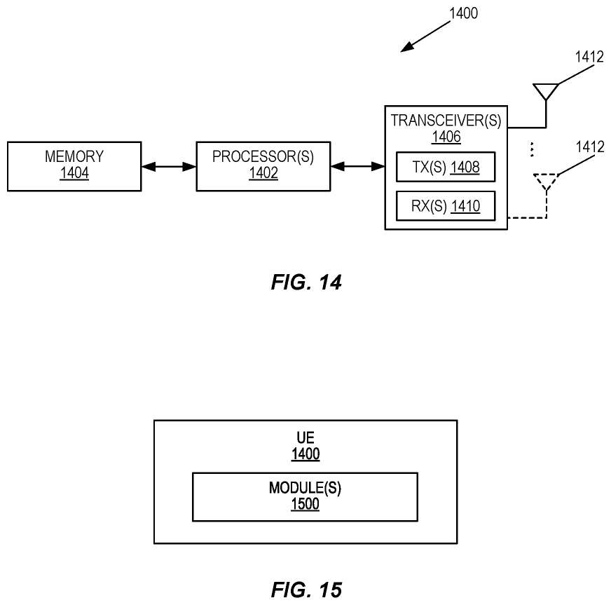

FIG. 11 is a schematic block diagram of a network node 1100 according to some embodiments of the present disclosure. Optional features are represented by dashed boxes. The network node 1100 may be, for example, a base station 402 or 406, a network node that implements all or part of the functionality of the base station 402 or gNB, the network node 700, 800, 900, or 1000 as described herein. As illustrated, the network node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, the network node 1100 may include one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of the network node 1100 as described herein (e.g., one or more functions of a base station 402 or 406, a network node that implements all or part of the functionality of the base station 402 or gNB, the network node 700, 800, 900, or 1000, as described herein). In some embodiments, the function(s) are implemented in software that is stored, e.g., in the memory 1106 and executed by the one or more processors 1104.

FIG. 12 is a schematic block diagram that illustrates a virtualized embodiment of the network node 1100 according to some embodiments of the present disclosure. Again, optional features are represented by dashed boxes. As used herein, a “virtualized” network node is an implementation of the network node 1100 in which at least a portion of the functionality of the network node 1100 is implemented as a virtual component(s) (e.g., via a virtual machine(s) executing on a physical processing node(s) in a network(s)). As illustrated, in this example, the network node 1100 may include the control system 1102 and/or the one or more radio units 1110, as described above. The control system 1102 may be connected to the radio unit(s) 1110 via, for example, an optical cable or the like. The network node 1100 includes one or more processing nodes 1200 coupled to or included as part of a network(s) 1202. If present, the control system 1102 or the radio unit(s) are connected to the processing node(s) 1200 via the network 1202. Each processing node 1200 includes one or more processors 1204 (e.g., CPUs, ASICs, FPGAs, and/or the like), memory 1206, and a network interface 1208.

In this example, functions 1210 of the network node 1100 described herein (e.g., one or more functions of a base station 402 or 406, a network node that implements all or part of the functionality of the base station 402 or gNB, the network node 700, 800, 900, or 1000, as described herein) are implemented at the one or more processing nodes 1200 or distributed across the one or more processing nodes 1200 and the control system 1102 and/or the radio unit(s) 1110 in any desired manner. In some particular embodiments, some or all of the functions 1210 of the network node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of the network node 1100 or a node (e.g., a processing node 1200) implementing one or more of the functions 1210 of the network node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the network node 1100 according to some other embodiments of the present disclosure. The network node 1100 includes one or more modules 1300, each of which is implemented in software. The module(s) 1300 provide the functionality of the network node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

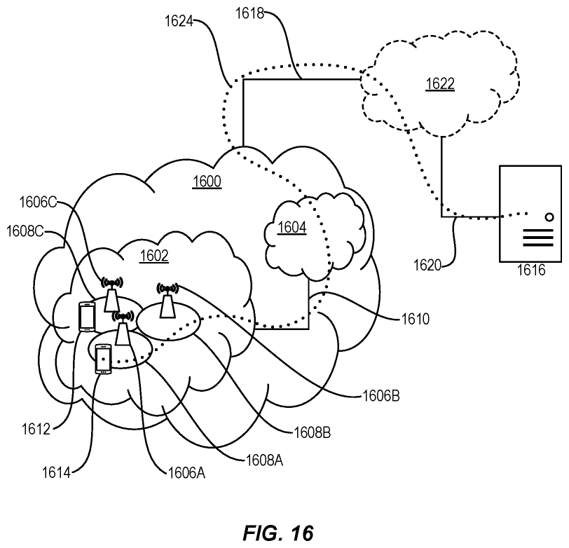

FIG. 14 is a schematic block diagram of a wireless communication device 1400 (e.g., a wireless communication device 412 or UE 412) according to some embodiments of the present disclosure. As illustrated, the wireless communication device 1400 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the wireless communication device 1400 described above may be fully or partially implemented in software that is, e.g., stored in the memory 1404 and executed by the processor(s) 1402. Note that the wireless communication device 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 1400 and/or allowing output of information from the wireless communication device 1400), a power supply (e.g., a battery and associated power circuitry), etc.

In some embodiments, a computer program including instructions which, when executed by at least one processor, causes the at least one processor to carry out the functionality of the wireless communication device 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 1400 according to some other embodiments of the present disclosure. The wireless communication device 1400 includes one or more modules 1500, each of which is implemented in software. The module(s) 1500 provide the functionality of the wireless communication device 1400 described herein.

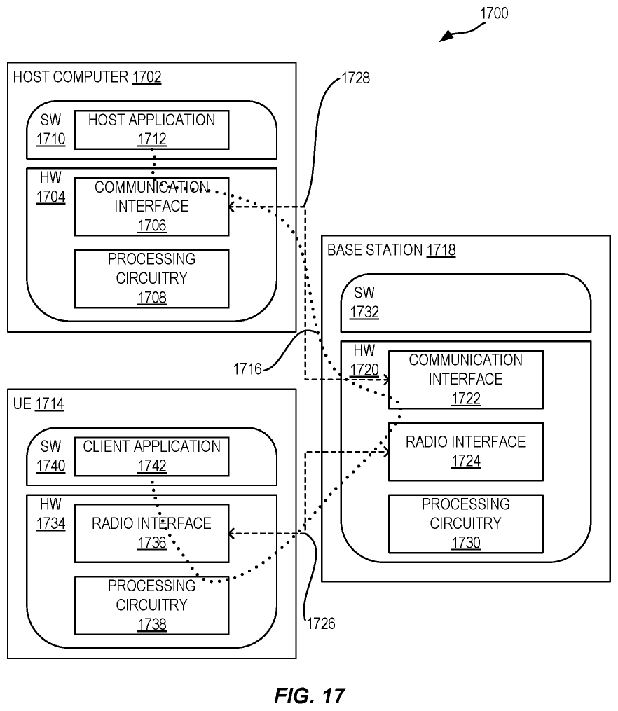

With reference to FIG. 16, in accordance with an embodiment, a communication system includes a telecommunication network 1600, such as a 3GPP-type cellular network, which comprises an access network 1602, such as a RAN, and a core network 1604. The access network 1602 comprises a plurality of base stations 1606A, 1606B, 1606C, such as Node Bs, eNBs, gNBs, or other types of wireless Access Points (APs), each defining a corresponding coverage area 1608A, 1608B, 1608C. Each base station 1606A, 1606B, 1606C is connectable to the core network 1604 over a wired or wireless connection 1610. A first UE 1612 located in coverage area 1608C is configured to wirelessly connect to, or be paged by, the corresponding base station 1606C. A second UE 1614 in coverage area 1608A is wirelessly connectable to the corresponding base station 1606A. While a plurality of UEs 1612, 1614 are illustrated in this example, the disclosed embodiments are equally applicable to a situation where a sole UE is in the coverage area or where a sole UE is connecting to the corresponding base station 1606.

The telecommunication network 1600 is itself connected to a host computer 1616, which may be embodied in the hardware and/or software of a standalone server, a cloud-implemented server, a distributed server, or as processing resources in a server farm. The host computer 1616 may be under the ownership or control of a service provider, or may be operated by the service provider or on behalf of the service provider. Connections 1618 and 1620 between the telecommunication network 1600 and the host computer 1616 may extend directly from the core network 1604 to the host computer 1616 or may go via an optional intermediate network 1622. The intermediate network 1622 may be one of, or a combination of more than one of, a public, private, or hosted network; the intermediate network 1622, if any, may be a backbone network or the Internet; in particular, the intermediate network 1622 may comprise two or more sub-networks (not shown).

The communication system of FIG. 16 as a whole enables connectivity between the connected UEs 1612, 1614 and the host computer 1616. The connectivity may be described as an Over-the-Top (OTT) connection 1624. The host computer 1616 and the connected UEs 1612, 1614 are configured to communicate data and/or signaling via the OTT connection 1624, using the access network 1602, the core network 1604, any intermediate network 1622, and possible further infrastructure (not shown) as intermediaries. The OTT connection 1624 may be transparent in the sense that the participating communication devices through which the OTT connection 1624 passes are unaware of routing of uplink and downlink communications. For example, the base station 1606 may not or need not be informed about the past routing of an incoming downlink communication with data originating from the host computer 1616 to be forwarded (e.g., handed over) to a connected UE 1612. Similarly, the base station 1606 need not be aware of the future routing of an outgoing uplink communication originating from the UE 1612 towards the host computer 1616.

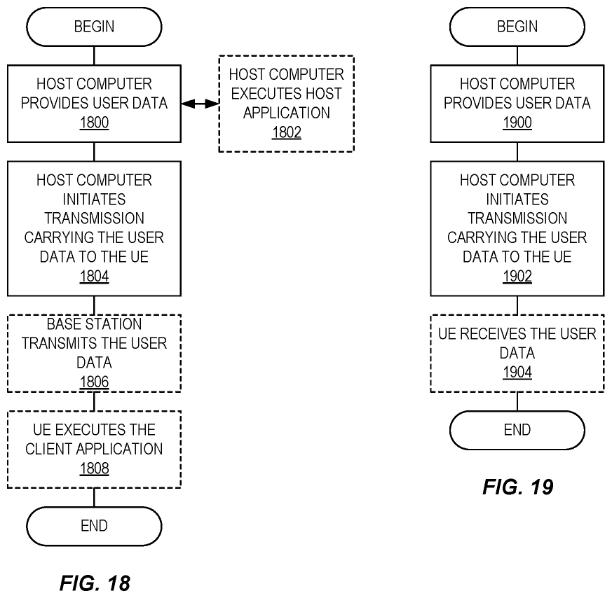

Example implementations, in accordance with an embodiment, of the UE, base station, and host computer discussed in the preceding paragraphs will now be described with reference to FIG. 17. In a communication system 1700, a host computer 1702 comprises hardware 1704 including a communication interface 1706 configured to set up and maintain a wired or wireless connection with an interface of a different communication device of the communication system 1700. The host computer 1702 further comprises processing circuitry 1708, which may have storage and/or processing capabilities. In particular, the processing circuitry 1708 may comprise one or more programmable processors, ASICs, FPGAs, or combinations of these (not shown) adapted to execute instructions. The host computer 1702 further comprises software 1710, which is stored in or accessible by the host computer 1702 and executable by the processing circuitry 1708. The software 1710 includes a host application 1712. The host application 1712 may be operable to provide a service to a remote user, such as a UE 1714 connecting via an OTT connection 1716 terminating at the UE 1714 and the host computer 1702. In providing the service to the remote user, the host application 1712 may provide user data which is transmitted using the OTT connection 1716.

The communication system 1700 further includes a base station 1718 provided in a telecommunication system and comprising hardware 1720 enabling it to communicate with the host computer 1702 and with the UE 1714. The hardware 1720 may include a communication interface 1722 for setting up and maintaining a wired or wireless connection with an interface of a different communication device of the communication system 1700, as well as a radio interface 1724 for setting up and maintaining at least a wireless connection 1726 with the UE 1714 located in a coverage area (not shown in FIG. 17) served by the base station 1718. The communication interface 1722 may be configured to facilitate a connection 1728 to the host computer 1702. The connection 1728 may be direct or it may pass through a core network (not shown in FIG. 17) of the telecommunication system and/or through one or more intermediate networks outside the telecommunication system. In the embodiment shown, the hardware 1720 of the base station 1718 further includes processing circuitry 1730, which may comprise one or more programmable processors, ASICs, FPGAs, or combinations of these (not shown) adapted to execute instructions. The base station 1718 further has software 1732 stored internally or accessible via an external connection.

The communication system 1700 further includes the UE 1714 already referred to. The UE's 1714 hardware 1734 may include a radio interface 1736 configured to set up and maintain a wireless connection 1726 with a base station serving a coverage area in which the UE 1714 is currently located. The hardware 1734 of the UE 1714 further includes processing circuitry 1738, which may comprise one or more programmable processors, ASICs, FPGAs, or combinations of these (not shown) adapted to execute instructions. The UE 1714 further comprises software 1740, which is stored in or accessible by the UE 1714 and executable by the processing circuitry 1738. The software 1740 includes a client application 1742. The client application 1742 may be operable to provide a service to a human or non-human user via the UE 1714, with the support of the host computer 1702. In the host computer 1702, the executing host application 1712 may communicate with the executing client application 1742 via the OTT connection 1716 terminating at the UE 1714 and the host computer 1702. In providing the service to the user, the client application 1742 may receive request data from the host application 1712 and provide user data in response to the request data. The OTT connection 1716 may transfer both the request data and the user data. The client application 1742 may interact with the user to generate the user data that it provides.

It is noted that the host computer 1702, the base station 1718, and the UE 1714 illustrated in FIG. 17 may be similar or identical to the host computer 1616, one of the base stations 1606A, 1606B, 1606C, and one of the UEs 1612, 1614 of FIG. 16, respectively. This is to say, the inner workings of these entities may be as shown in FIG. 17 and independently, the surrounding network topology may be that of FIG. 16.

In FIG. 17, the OTT connection 1716 has been drawn abstractly to illustrate the communication between the host computer 1702 and the UE 1714 via the base station 1718 without explicit reference to any intermediary devices and the precise routing of messages via these devices. The network infrastructure may determine the routing, which may be configured to hide from the UE 1714 or from the service provider operating the host computer 1702, or both. While the OTT connection 1716 is active, the network infrastructure may further take decisions by which it dynamically changes the routing (e.g., on the basis of load balancing consideration or reconfiguration of the network).

The wireless connection 1726 between the UE 1714 and the base station 1718 is in accordance with the teachings of the embodiments described throughout this disclosure. One or more of the various embodiments improve the performance of OTT services provided to the UE 1714 using the OTT connection 1716, in which the wireless connection 1726 forms the last segment.

A measurement procedure may be provided for the purpose of monitoring data rate, latency, and other factors on which the one or more embodiments improve. There may further be an optional network functionality for reconfiguring the OTT connection 1716 between the host computer 1702 and the UE 1714, in response to variations in the measurement results. The measurement procedure and/or the network functionality for reconfiguring the OTT connection 1716 may be implemented in the software 1710 and the hardware 1704 of the host computer 1702 or in the software 1740 and the hardware 1734 of the UE 1714, or both. In some embodiments, sensors (not shown) may be deployed in or in association with communication devices through which the OTT connection 1716 passes; the sensors may participate in the measurement procedure by supplying values of the monitored quantities exemplified above, or supplying values of other physical quantities from which the software 1710, 1740 may compute or estimate the monitored quantities. The reconfiguring of the OTT connection 1716 may include message format, retransmission settings, preferred routing, etc.; the reconfiguring need not affect the base station 1718, and it may be unknown or imperceptible to the base station 1718. Such procedures and functionalities may be known and practiced in the art. In certain embodiments, measurements may involve proprietary UE signaling facilitating the host computer 1702's measurements of throughput, propagation times, latency, and the like. The measurements may be implemented in that the software 1710 and 1740 causes messages to be transmitted, in particular empty or ‘dummy’ messages, using the OTT connection 1716 while it monitors propagation times, errors, etc.

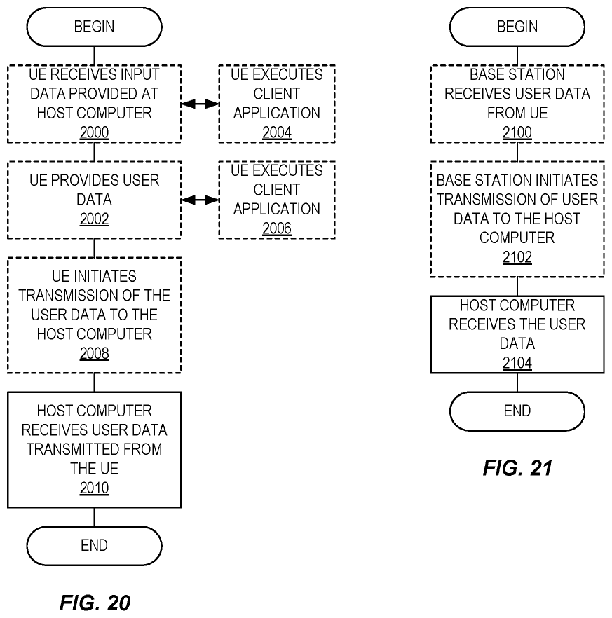

FIG. 18 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 18 will be included in this section. In step 1800, the host computer provides user data. In sub-step 1802 (which may be optional) of step 1800, the host computer provides the user data by executing a host application. In step 1804, the host computer initiates a transmission carrying the user data to the UE. In step 1806 (which may be optional), the base station transmits to the UE the user data which was carried in the transmission that the host computer initiated, in accordance with the teachings of the embodiments described throughout this disclosure. In step 1808 (which may also be optional), the UE executes a client application associated with the host application executed by the host computer.

FIG. 19 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 19 will be included in this section. In step 1900 of the method, the host computer provides user data. In an optional sub-step (not shown) the host computer provides the user data by executing a host application. In step 1902, the host computer initiates a transmission carrying the user data to the UE. The transmission may pass via the base station, in accordance with the teachings of the embodiments described throughout this disclosure. In step 1904 (which may be optional), the UE receives the user data carried in the transmission.

FIG. 20 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 20 will be included in this section. In step 2000 (which may be optional), the UE receives input data provided by the host computer. Additionally or alternatively, in step 2002, the UE provides user data. In sub-step 2004 (which may be optional) of step 2000, the UE provides the user data by executing a client application. In sub-step 2006 (which may be optional) of step 2002, the UE executes a client application which provides the user data in reaction to the received input data provided by the host computer. In providing the user data, the executed client application may further consider user input received from the user. Regardless of the specific manner in which the user data was provided, the UE initiates, in sub-step 2008 (which may be optional), transmission of the user data to the host computer. In step 2010 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 21 will be included in this section. In step 2100 (which may be optional), in accordance with the teachings of the embodiments described throughout this disclosure, the base station receives user data from the UE. In step 2102 (which may be optional), the base station initiates transmission of the received user data to the host computer. In step 2104 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### GROUP A EMBODIMENTS

Embodiment 1: A method performed by a wireless communication device (412) comprising:
while in inactive state, transmitting (702; 802) a message to a network node, wherein the message comprises either:
   a Medium Access Control, MAC, Control Element, CE, that comprises information that indicates one or more System Information Blocks, SIBs, and/or one or more position SIBs, posSIBs, being requested by the wireless communication device (412); or
   a Radio Resource Control, RRC, message that comprises information that indicates one or more SIBs and/or one or more posSIBs being requested by the wireless communication device (412).

Embodiment 2: The method of embodiment 1 wherein the messages comprises a MAC CE that comprises information that indicates one or more SIBs and/or one or more posSIBs being requested by the wireless communication device (412).

Embodiment 3: The method of embodiment 2 wherein the MAC CE further comprises an indication that the wireless communication device (412) supports SmallData Transmission, SDT, functionality for requesting the one or more SIBs and/or the one or more posSIBs.

Embodiment 4: The method of embodiment 2 wherein the wireless communication device (412) indicates, to the network node, that the wireless communication device (412) supports SmallData Transmission, SDT, functionality for requesting the one or more SIBs and/or the one or more posSIBs via:
capability information reported to the network node, or
use of a Logical Channel Identity, LCID, or enhanced Logical Channel Identity, eLCID, in the MAC CE, or
use of a certain random access preamble resource group for transmission of an associated random access preamble.

Embodiment 5: The method of any of embodiments 2 to 4 wherein the MAC CE further comprises an identity of the wireless communication device (412).

Embodiment 6: The method of embodiment 5 wherein the identity of the wireless communication device (412) is either an I-RNTI or Short I-RNTI of the wireless communication device (412).

Embodiment 7: The method of embodiment 6 wherein the MAC CE further comprises an indicator that indicates whether the identity of the wireless communication device (412) comprised in the MAC CE is an I-RNTI or a Short I-RNTI.

Embodiment 8: The method of any of embodiments 2 to 7 wherein the MAC CE further comprises information that indicates whether the one or more SIBs and/or the one or more posSIBs being requested by the wireless communication device (412) are one or more SIBs or one or more posSIBs.

Embodiment 9: The method of any of embodiments 2 to 8 wherein the MAC CE comprises a subheader that comprises an enhanced, eLCID, wherein the eLCID comprises a plurality of bits that that indicate which of a plurality of SIBs and/or posSIBs are being requested by the wireless communication device (412).

Embodiment 10: The method of embodiment 9 wherein the MAC CE comprises a flag in the subheader or in the eLCID that indicates whether the one or more SIBs and/or the one or more posSIBs being requested by the wireless communication device (412) are one or more SIBs or one or more posSIBs.

Embodiment 11: The method of embodiment 9 or 10 wherein the eLCID further comprises an identity of the wireless communication device (412).

Embodiment 12: The method of embodiment 11 wherein the identity of the wireless communication device (412) is either an I-RNTI or Short I-RNTI of the wireless communication device (412).

Embodiment 13: The method of embodiment 12 wherein the eLCID further comprises an indicator that indicates whether the identity of the wireless communication device (412) comprised in the eLCID is an I-RNTI or a Short I-RNTI.

Embodiment 14: The method of embodiment 1 wherein the messages comprises a RRC message that comprises:
information that indicates one or more SIBs and/or one or more posSIBs being requested by the wireless communication device (412); and
an identity of the wireless communication device (412) and/or an indication that the wireless communication device (412) supports a Small Data Transmission, SDT, functionality for requesting the one or more SIBs and/or the one or more posSIBs and/or an indication of a capability of the wireless communication device (412) to obtain SIBs and/or posSIBs via downlink SDT transmission.

Embodiment 15: The method of embodiment 14 wherein the RRC message comprises a bitmap or explicit indication that indicates one or more SIBs and/or one or more posSIBs being requested by the wireless communication device (412).

Embodiment 16: The method of embodiment 14 or 15 wherein transmitting (802) the message comprises transmitting (802) the RRC message to be used for communication of small data transmission (SDT) framework instead of a legacy RRC message that is normally used when transitioning from an idle/inactive state or in a connected state.

Embodiment 17: The method of embodiment 14 or 15 wherein transmitting (802) the message comprises embedding (802) the RRC message comprising capability of receiving SIBs/posSIBs using small data transmission framework (SDT) within a legacy RRC message that is normally used when transitioning from an idle/inactive state or in a connected state.

Embodiment 18: The method of any of embodiments 14 to 17 wherein transmitting (802) the message comprises transmitting (802) the RRC message in either a Msg3 of a 4-step random access for SDT procedure or MsgA of a 2-step random access for SDT procedure.

Embodiment 19: The method of any of embodiments 14 to 18 wherein the RRC message further comprises information that indicates that the wireless communication device (412) supports a Small Data Transmission, SDT, functionality for requesting the one or more SIBs and/or the one or more posSIBs.

Embodiment 20: The method of any of embodiments 14 to 19 wherein an identity of the wireless communication device (412) is not included in the RRC message, but is included in a MAC CE transmitted by the wireless communication device (412) to the network node either before or after the RRC message.

Embodiment 21: The method of any of embodiments 1 to 20 further comprising receiving (704) at least one of the one or more SIBs and/or at least one of the one or more posSIBs (e.g., via SDT) as part of a Msg 4 of an associated random access or as part of an RRC Release message.

Embodiment 22: The method of any of embodiments 1 to 20 further comprising receiving (704; 804) at least one of the one or more SIBs and/or at least one of the one or more posSIBs via broadcast.

Embodiment 23: The method of embodiment 22 wherein receiving (704; 804) the at least one of the one or more SIBs and/or the at least one of the one or more posSIBs via broadcast comprises receiving a broadcast status flag(s) associated to the at least one of the one or more SIBs and/or the at least one of the one or more posSIBs where the broadcast status flag(s) is(are) changed to indicate that the at least one of the one or more SIBs and/or the at least one of the one or more posSIBs are broadcasted.

Embodiment 24: The method of any of embodiments 1 to 20 further comprising receiving (704; 804) a message that disables the request for the one or more SIBs and/or the one or more posSIBs.

Embodiment 25: The method of any of embodiments 1 to 24 wherein transmitting the message (702; 802) comprises transmitting (902) a MsgA in a 2-step random access, where the MsgA comprises a random access preamble, a RRC Resume Request, data, and the message.

Embodiment 26: The method of any of embodiments 1 to 24 wherein transmitting the message (702; 802) comprises transmitting (1002) a Msg3 in a 4-step random access, where the Msg3 comprises a RRC Resume Request, data, and the message.

Embodiment 27: The method of any of the previous embodiments, further comprising: providing user data; and forwarding the user data to a host computer via the transmission to the base station.

### GROUP B EMBODIMENTS

Embodiment 28: A method performed by a network node (700; 800; 900; 1000), the method comprising:
while a wireless communication device (412) is in an inactive state, receiving (702; 802) a message from the wireless communication device (412), wherein the message comprises either:
   a Medium Access Control, MAC, Control Element, CE, that comprises information that indicates one or more System Information Blocks, SIBs, and/or one or more position SIBs, posSIBs, being requested by the wireless communication device (412); or
   a Radio Resource Control, RRC, message that comprises information that indicates one or more SIBs and/or one or more posSIBs being requested by the wireless communication device (412).

Embodiment 29: The method of embodiment 28 wherein the messages comprises a MAC CE that comprises information that indicates one or more SIBs and/or one or more posSIBs being requested by the wireless communication device (412).

Embodiment 30: The method of embodiment 29 wherein the MAC CE further comprises an indication that the wireless communication device (412) supports Small Data Transmission, SDT, functionality for requesting the one or more SIBs and/or the one or more posSIBs.

Embodiment 31: The method of embodiment 29 wherein the network node determines that the wireless communication device (412) supports Small Data Transmission, SDT, functionality for requesting the one or more SIBs and/or the one or more posSIBs via:
capability information reported from the wireless communication device (412) to the network node, or
use of a Logical Channel Identity, LCID, or enhanced Logical Channel Identity, eLCID, in the MAC CE, or
use of a certain random access preamble resource group for transmission of an associated random access preamble.

Embodiment 32: The method of any of embodiments 29 to 31 wherein the MAC CE further comprises an identity of the wireless communication device (412).

Embodiment 33: The method of embodiment 32 wherein the identity of the wireless communication device (412) is either an I-RNTI or Short I-RNTI of the wireless communication device (412).

Embodiment 34: The method of embodiment 33 wherein the MAC CE further comprises an indicator that indicates whether the identity of the wireless communication device (412) comprised in the MAC CE is an I-RNTI or a Short I-RNTI.

Embodiment 35: The method of any of embodiments 29 to 34 wherein the MAC CE further comprises information that indicates whether the one or more SIBs and/or the one or more posSIBs being requested by the wireless communication device (412) are one or more SIBs or one or more posSIBs.

Embodiment 36: The method of any of embodiments 29 to 35 wherein the MAC CE comprises a subheader that comprises an enhanced, eLCID, wherein the eLCID comprises a plurality of bits that that indicate which of a plurality of SIBs and/or posSIBs are being requested by the wireless communication device (412).

Embodiment 37: The method of embodiment 36 wherein the MAC CE comprises a flag in the subheader or in the eLCID that indicates whether the one or more SIBs and/or the one or more posSIBs being requested by the wireless communication device (412) are one or more SIBs or one or more posSIBs.

Embodiment 38: The method of embodiment 36 or 37 wherein the eLCID further comprises an identity of the wireless communication device (412).

Embodiment 39: The method of embodiment 38 wherein the identity of the wireless communication device (412) is either an I-RNTI or Short I-RNTI of the wireless communication device (412).

Embodiment 40: The method of embodiment 39 wherein the eLCID further comprises an indicator that indicates whether the identity of the wireless communication device (412) comprised in the eLCID is an I-RNTI or a Short I-RNTI.

Embodiment 41: The method of embodiment 28 wherein the messages comprises a RRC message that comprises information that indicates one or more SIBs and/or one or more posSIBs being requested by the wireless communication device (412).

Embodiment 42: The method of embodiment 41 wherein the RRC message comprises a bitmap or explicit indication that indicates one or more SIBs and/or one or more posSIBs being requested by the wireless communication device (412).

Embodiment 43: The method of embodiment 41 or 42 wherein receiving (802) the message comprises receiving (802) the RRC message instead of a legacy RRC message that is normally used when transitioning from an idle state or a connected state.

Embodiment 44: The method of embodiment 41 or 42 wherein receiving (802) the message comprises receiving (802) the RRC message embedded within a legacy RRC message that is normally used when transitioning from an idle state or a connected state.

Embodiment 45: The method of any of embodiments 41 to 44 wherein receiving (802) the message comprises receiving (802) the RRC message in either a Msg3 of a 4-step random access for SDT procedure or MsgA of a 2-step random access for SDT procedure.

Embodiment 46: The method of any of embodiments 41 to 45 wherein the RRC message further comprises information that indicates that the wireless communication device (412) supports a Small Data Transmission, SDT, functionality for requesting the one or more SIBs and/or the one or more posSIBs.

Embodiment 47: The method of any of embodiments 41 to 46 wherein an identity of the wireless communication device (412) is not included in the RRC message, but is included in a MAC CE received from the wireless communication device (412) either before or after the RRC message.

Embodiment 48: The method of any of embodiments 28 to 47 further comprising transmitting (704) at least one of the one or more SIBs and/or at least one of the one or more posSIBs to the wireless communication device (412) (e.g., via SDT) as part of a Msg 4 of an associated random access or as part of an RRC Release message.

Embodiment 49: The method of any of embodiments 28 to 47 further comprising broadcasting (704; 804) at least one of the one or more SIBs and/or at least one of the one or more posSIBs.

Embodiment 50: The method of embodiment 49 wherein broadcasting (704; 804) the at least one of the one or more SIBs and/or the at least one of the one or more posSIBs comprises sending a broadcast status flag(s) associated to the at least one of the one or more SIBs and/or the at least one of the one or more posSIBs where the broadcast status flag(s) is(are) changed to indicate that the at least one of the one or more SIBs and/or the at least one of the one or more posSIBs are broadcasted.

Embodiment 51: The method of any of embodiments 28 to 47 further comprising transmitting (704; 804) a message that disables the request for the one or more SIBs and/or the one or more posSIBs.

Embodiment 52: The method of any of embodiments 28 to 51 wherein receiving the message (702; 802) comprises receiving (902) a MsgA in a 2-step random access, where the MsgA comprises a random access preamble, a RRC Resume Request, data, and the message.

Embodiment 53: The method of any of embodiments 28 to 51 wherein receiving the message (702; 802) comprises receiving (1002) a Msg3 in a 4-step random access, where the Msg3 comprises a RRC Resume Request, data, and the message.

Embodiment 54: The method of any of the previous embodiments, further comprising: obtaining user data; and forwarding the user data to a host computer or a wireless communication device.

### GROUP C EMBODIMENTS

Embodiment 55: A wireless communication device comprising: processing circuitry configured to perform any of the steps of any of the Group A embodiments; and power supply circuitry configured to supply power to the wireless communication device.

Embodiment 56: A base station comprising: processing circuitry configured to perform any of the steps of any of the Group B embodiments; and power supply circuitry configured to supply power to the base station.

Embodiment 57: A User Equipment, UE, comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 58: A communication system including a host computer comprising:
processing circuitry configured to provide user data; and
a communication interface configured to forward the user data to a cellular network for transmission to a User Equipment, UE;
wherein the cellular network comprises a base station having a radio interface and processing circuitry, the base station's processing circuitry configured to perform any of the steps of any of the Group B embodiments.

Embodiment 59: The communication system of the previous embodiment further including the base station.

Embodiment 60: The communication system of the previous 2 embodiments, further including the UE, wherein the UE is configured to communicate with the base station.

Embodiment 61: The communication system of the previous 3 embodiments, wherein: the processing circuitry of the host computer is configured to execute a host application, thereby providing the user data; and the UE comprises processing circuitry configured to execute a client application associated with the host application.

Embodiment 62: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 63: The method of the previous embodiment, further comprising, at the base station, transmitting the user data.

Embodiment 64: The method of the previous 2 embodiments, wherein the user data is provided at the host computer by executing a host application, the method further comprising, at the UE, executing a client application associated with the host application.

Embodiment 65: A User Equipment, UE, configured to communicate with a base station, the UE comprising a radio interface and processing circuitry configured to perform the method of the previous 3 embodiments.

Embodiment 66: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 67: The communication system of the previous embodiment, wherein the cellular network further includes a base station configured to communicate with the UE.

Embodiment 68: The communication system of the previous 2 embodiments, wherein: the processing circuitry of the host computer is configured to execute a host application, thereby providing the user data; and the UE's processing circuitry is configured to execute a client application associated with the host application.

Embodiment 69: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 70: The method of the previous embodiment, further comprising at the UE, receiving the user data from the base station.

Embodiment 71: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 72: The communication system of the previous embodiment, further including the UE.

Embodiment 73: The communication system of the previous 2 embodiments, further including the base station, wherein the base station comprises a radio interface configured to communicate with the UE and a communication interface configured to forward to the host computer the user data carried by a transmission from the UE to the base station.

Embodiment 74: The communication system of the previous 3 embodiments, wherein: the processing circuitry of the host computer is configured to execute a host application; and the UE's processing circuitry is configured to execute a client application associated with the host application, thereby providing the user data.

Embodiment 75: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 76: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 77: The method of the previous embodiment, further comprising, at the UE, providing the user data to the base station.

Embodiment 78: The method of the previous 2 embodiments, further comprising: at the UE, executing a client application, thereby providing the user data to be transmitted; and at the host computer, executing a host application associated with the client application.

Embodiment 79: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 80: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 81: The communication system of the previous embodiment further including the base station.

Embodiment 82: The communication system of the previous 2 embodiments, further including the UE, wherein the UE is configured to communicate with the base station.

Embodiment 83: The communication system of the previous 3 embodiments, wherein: the processing circuitry of the host computer is configured to execute a host application; and the UE is configured to execute a client application associated with the host application, thereby providing the user data to be received by the host computer.

Embodiment 84: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 85: The method of the previous embodiment, further comprising at the base station, receiving the user data from the UE.

Embodiment 86: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a wireless communication device comprising:
while in inactive state, transmitting a message to a network node, wherein the message comprises:
an identity, ID, of the wireless communication device;
information that indicates one or more System Information Blocks, SIBs, and/or one or more position SIBs, posSIBs, being requested by the wireless communication device; and
an indication that the wireless communication device supports a Small Data Transmission, SDI, functionality for requesting the one or more SIBs and/or the one or more posSIBs and/or an indication of a capability of the wireless communication device to obtain SIBs and/or posSIBs via downlink SDT transmission.

2. The method of claim 1 wherein the message comprises a Medium Access Control, MAC, Control Element, CE, that comprises the information that indicates the one or more SIBs and/or the one or more posSIBs being requested by the wireless communication device.

3. (canceled)

4. The method of claim 2 wherein the wireless communication device indicates, to the network node, that the wireless communication device supports SmallData Transmission, SDT, functionality for requesting the one or more SIBs and/or the one or more posSIBs via:
capability information reported to the network node, or
use of a Logical Channel Identity, LCID, or enhanced Logical Channel Identity, eLCID, in the MAC CE, or
use of a certain random access preamble resource group for transmission of an associated random access preamble.

5. The method of claim 2, wherein the MAC CE further comprises the identity of the wireless communication device.

6. The method of claim 2, wherein the identity of the wireless communication device is either an Inactive mode Radio Network Temporary Identifier, I-RNTI, or Short I-RNTI of the wireless communication device.

7. The method of claim 6 wherein the MAC CE further comprises an indicator that indicates whether the identity of the wireless communication device comprised in the MAC CE is an I-RNTI or a Short I-RNTI.

8. The method of claim 2, wherein the MAC CE further comprises information that indicates whether the one or more SIBs and/or the one or more posSIBs being requested by the wireless communication device are one or more SIBs or one or more posSIBs.

9. The method of claim 2, wherein the MAC CE comprises a subheader that comprises an enhanced Logical Channel Identity, eLCID, wherein the eLCID comprises a plurality of bits that that indicate which of a plurality of SIBs and/or posSIBs are being requested by the wireless communication device.

10. The method of claim 9 wherein the MAC CE comprises a flag in the subheader or in the eLCID that indicates whether the one or more SIBs and/or the one or more posSIBs being requested by the wireless communication device are one or more SIBs or one or more posSIBs.

11. The method of claim 9 wherein the eLCID further comprises the identity of the wireless communication device.

12. The method of claim 11 wherein the identity of the wireless communication device is either an I-RNTI or Short I-RNTI of the wireless communication device.

13. The method of claim 12 wherein the eLCID further comprises an indicator that indicates whether the identity of the wireless communication device comprised in the eLCID is an I-RNTI or a Short I-RNTI.

14. The method of claim 1 wherein the message comprises a Radio Resource Control, RRC, message that comprises the information that indicates the one or more SIBs and/or the one or more posSIBs being requested by the wireless communication device.

15. (canceled)

16. The method of claim 14 wherein the information that indicates the one or more SIBs and/or the one or more posSIBs being requested by the wireless communication device comprises a bitmap or explicit indication that indicates one or more SIBs and/or one or more posSIBs being requested by the wireless communication device.

17. The method of claim 14, wherein transmitting the message comprises transmitting the RRC message to be used for communication of small data transmission, SDT, framework instead of a legacy RRC message that is normally used when transitioning from an idle/inactive state or in a connected state.

18. The method of claim 14, wherein transmitting the message comprises embedding the RRC message comprising information that indicates a capability of receiving SIBs and/or posSIBs using small data transmission, SDT, framework within a legacy RRC message that is normally used when transitioning from an idle/inactive state or in a connected state.

19. The method of claim 14, wherein transmitting the message comprises transmitting the RRC message in either a Msg3 of a 4-step random access for a SDT procedure or MsgA of a 2-step random access for a SDT procedure.

20. The method of claim 14, wherein the identity of the wireless communication device is not included in the RRC message, but is included in a Medium Access Control, MAC, Control Element, CE, transmitted by the wireless communication device to the network node either before or after the RRC message.

21. The method of claim 1, further comprising receiving at least one of the one or more SIBs and/or at least one of the one or more posSIBs as part of a Msg 4 of an associated random access or as part of an RRC Release message.

22. The method of claim 1, further comprising receiving at least one of the one or more SIBs and/or at least one of the one or more posSIBs via broadcast.

23. The method of claim 22 wherein receiving the at least one of the one or more SIBs and/or the at least one of the one or more posSIBs via broadcast comprises receiving a broadcast status flag(s) associated to the at least one of the one or more SIBs and/or the at least one of the one or more posSIBs where the broadcast status flag(s) is(are) changed to indicate that the at least one of the one or more SIBs and/or the at least one of the one or more posSIBs are broadcasted.

24. The method of claim 1, further comprising receiving a message that disables the request for the one or more SIBs and/or the one or more posSIBs.

25. The method of claim 1, wherein transmitting the message comprises either:
transmitting a MsgA in a 2-step random access, where the MsgA comprises a random access preamble, a RRC Resume Request, data, and the message; or
transmitting a Msg3 in a 4-step random access, where the Msg3 comprises a RRC Resume Request, data, and the message.

26-28. (canceled)

29. A wireless communication device comprising:
one or more transmitters;
one or more receivers; and
processing circuitry associated with the one or more transmitters and the one or more receivers, the processing circuitry configured to cause the wireless communication device to, while in inactive state, transmit a message to a network node, wherein the message comprises:
an identity, ID, of the wireless communication device;
information that indicates one or more System Information Blocks, SIBs, and/or one or more position SIBs, posSIBs, being requested by the wireless communication device; and
an indication that the wireless communication device supports a Small Data Transmission, SDT, functionality for requesting the one or more SIBs and/or the one or more posSIBs and/or an indication of a capability of the wireless communication device to obtain SIBs and/or posSIBs via downlink SDT transmission.

30. (canceled)

31. A method performed by a network node, the method comprising:
while a wireless communication device is in an inactive state, receiving a message from the wireless communication device, wherein the message comprises:
an identity, ID, of the wireless communication device;
information that indicates one or more System Information Blocks, SIBs, and/or one or more position SIBs, posSIBs, being requested by the wireless communication device; and
an indication that the wireless communication device supports a Small Data Transmission, SDT, functionality for requesting the one or more SIBs and/or the one or more posSIBs and/or an indication of a capability of the wireless communication device to obtain SIBs and/or posSIBs via downlink SDT transmission.

32-58. (canceled)

59. A network node comprising processing circuitry configured to cause the network node to:
while a wireless communication device is in an inactive state, receive a message from the wireless communication device, wherein the message comprises:
an identity, ID, of the wireless communication device;
information that indicates one or more System Information Blocks, SIBs, and/or one or more position SIBs, posSIBs, being requested by the wireless communication device; and
an indication that the wireless communication device supports a Small Data Transmission, SDT, functionality for requesting the one or more SIBs and/or the one or more posSIBs and/or an indication of a capability of the wireless communication device to obtain SIBs and/or posSIBs via downlink SDT transmission.

60. (canceled)
